(19) United States
(12) Patent Application Publication
(10) Pub. No.: US 2011/0055099 A1
(43) Pub. Date: Mar. 3, 2011

(54) Automated Systems and Methods for Matching Healthcare Professionals with Healthcare Organizations on a Temporary Basis

(76) Inventors: Geoffrey Aaron Paul, Atlanta, GA (US); Robert Baxter Shumard, Dunwoody, GA (US)

(21) Appl. No.: 12/873,699

(22) Filed: Sep. 1, 2010

Related U.S. Application Data
(60) Provisional application No. 61/275,676, filed on Sep. 1, 2009.

(51) Int. Cl. G06Q 10/00

(52) U.S. Cl. 705/321

(57) ABSTRACT

Automated web-based systems and methods for matching healthcare professionals with healthcare organizations on a temporary basis are disclosed. The systems and methods of the present invention utilize a secure online portal to facilitate communication between healthcare organizations and locum tenens recruitment agencies. The present invention automates and manages all aspects of the connecting of healthcare organizations and vendors for the purpose of matching and placing of temporary medical professionals with healthcare organizations.

### CROSS-REFERENCE TO RELATED APPLICATIONS

This patent application claims the benefit of priority to U.S. Provisional Patent Application Ser. No. 61/275,676 filed on Sep. 1, 2009, the subject matter of which is hereby incorporated by reference in its entirety.

### TECHNICAL FIELD

The present invention relates to automated methods and web-based systems for matching healthcare providers with healthcare organizations on a temporary basis.

### BACKGROUND

Locum tenens is the common term used to refer to the temporary staffing of healthcare professionals at healthcare organizations, such as hospitals, clinics and private medical practices. Historically, the matching of medical professionals with temporary work has been facilitated by staffing agencies focusing on locum tenens recruitments. Such facilitation is often manual in nature in that it involves telephone and/or written solicitations, contract negotiations, resume review, and rate negotiations between a healthcare organization and staffing agencies so that the an appropriate individual can be identified and referred for the necessary dates and at an appropriate rate. This manual staffing model is time consuming and expensive in that it requires multiple contracts between healthcare organizations, staffing agencies and locum tenens healthcare professionals.

What is needed in the art is an automated system and method for matching healthcare providers with healthcare organizations on a temporary basis, as well as an automated system and method for managing aspects of such a temporary/supplemental staffing relationship.

### SUMMARY

The present invention addresses the need for an automated system and method for matching healthcare providers with healthcare organizations on a temporary basis. The systems and methods of the present invention enable the efficient, cost-effective matching of healthcare providers with healthcare organizations on a temporary basis while providing a clear, transparent record of the business relationship.

Accordingly, the present invention is directed to methods of matching a healthcare professional via a staffing agency (i.e., vendor) with a healthcare organization on a temporary basis using a secure web-based system. In one exemplary embodiment, the method for matching a healthcare professional with a healthcare organization on a temporary basis comprises: providing a secure web-based system for healthcare organizations and vendors for the purpose of matching a healthcare professional with a healthcare organization on a temporary basis; providing independent access to the secure web-based system via individual user names and passwords for (i) one or more healthcare facility administrators, (ii) one or more vendors, and (iii) one or more support personnel; providing a first set of website selection options for the one or more healthcare facility administrators; and providing a second set of website selection options for the one or more vendors; wherein utilization of website selection options within the first and second sets of website selection options by the one or more healthcare facility administrators and the one or more vendors results in an accepted match between (1) a specific healthcare provider and (2) a specific facility of a healthcare organization for a temporary assignment performed by the specific healthcare provider at the specific facility.

Utilization of website selection options within the first and second sets of website selection options by the one or more healthcare facility administrators and the one or more vendors desirably results in the formation of a contractual agreement between (1) a specific vendor and (2) a specific facility for a temporary assignment to be performed by a specific healthcare provider at the specific facility.

In another exemplary embodiment, the method for matching a healthcare professional with a healthcare organization on a temporary basis comprises creating an assignment for temporary healthcare provider services using a secure web-based system; submitting the assignment along with a request to bid on the assignment to one or more potential bidders via the secure web-based system; in response to receiving one or more bids from the one or more potential bidders for the assignment via the secure web-based system, accepting a bid for the assignment via the secure web-based system, wherein said accepting step creates an electronic confirmation agreement that is made a part of and governed under terms of a master agreement between the healthcare organization and a winning bidder; and providing notification of acceptance to the winning bidder for an accepted bid via the secure web-based system.

In exemplary embodiments for connecting vendors to healthcare organizations for the purpose of matching healthcare professionals with healthcare organizations on a temporary basis, the method may further comprise a number of possible additional steps utilizing the web-based system. Possible additional steps include, but are not limited to, accessing a web-based program for connecting healthcare organizations with vendors for the purpose of recruiting healthcare professionals to work on a temporary basis by using a user name and password; providing assignment details that may be viewable by one or more potential bidders for the assignment; reviewing bids from one or more vendors/bidders including bid details (e.g., bid rates) by clicking on individual bid numbers assigned to each bid; reviewing details of the potential healthcare provider (e.g., the provider's curriculum vitae (CV), references, copies of certifications and licenses, and employment eligibility verification); providing notice of a declined bid (and reasons for the decline) to a vendor/bidder; managing the transition of an awarded (i.e., pending) assignment to an active assignment; managing the details of an active assignment (i.e., during the fixed time period of the assignment); and managing the aspects of a past assignment (i.e., a completed assignment).

In yet another exemplary embodiment, the method for connecting a healthcare organization with a vendor for the purpose of matching the healthcare organization with a healthcare professional to work on a temporary basis comprises the steps of: in response to receiving a request to bid on an assignment for temporary healthcare provider services from a hospital administrator via a secure web-based system, submitting a bid for the assignment via the secure web-based system; and in response to receiving notification of acceptance of the bid from the hospital administrator, electronically signing a confirmation agreement for the assignment via the secure web-based system.

The disclosed methods for connecting healthcare organizations with vendors for the purpose of recruiting healthcare professionals to work on a temporary basis in the healthcare organizations desirably result in an electronically executed confirmation agreement, which forms part of a master agreement, via the secure web-based system so as to form a contractual agreement between (1) a specific vendor (i.e., bidder, or staffing agency) and (2) a specific healthcare organization for a temporary assignment performed by a specific healthcare provider at a specific facility within the healthcare organization.

The present invention is further directed to computing systems capable of performing the disclosed methods for connecting vendors and healthcare organizations for the purpose of matching a healthcare professional with a healthcare organization on a temporary basis. Typically, a given computing system comprises at least one application module usable on the computing system, wherein the at least one application module comprises application code loaded thereon for performing one or more of the disclosed methods for connecting vendors and healthcare organizations for the purpose of matching a healthcare professional with a healthcare organization on a temporary basis.

The present invention is even further directed to computing systems comprising at least one device operatively adapted to access a secure web-based system and utilize one or more of the disclosed methods for connecting healthcare organizations with vendors for the purpose of matching healthcare professionals with healthcare organizations on a temporary basis. Desirably, a given computing system comprises at least one device operatively adapted to access the secure web-based system and utilize one or more of the disclosed methods for connecting healthcare organizations with vendors for the purpose of matching healthcare professionals with healthcare organizations on a temporary basis so as to facilitate reaching an accepted match between (1) a specific healthcare provider and (2) a specific facility of a healthcare organization for a temporary assignment performed by the specific healthcare provider at the specific facility, as well as the electronic execution of a confirmation agreement, which forms part of a master agreement via the secure web-based system so as to form a contractual agreement between (1) the specific vendor and (2) the specific facility of the healthcare organization for the temporary assignment to be performed by the specific healthcare provider at the specific facility.

These and other features and advantages of the present invention will become apparent after a review of the following detailed description of the disclosed embodiments and the appended claims.

### BRIEF DESCRIPTION OF THE FIGURES

The present invention is further described with reference to the appended figures, wherein:

FIG. 1 depicts a schematic of participants utilizing the secure web-based systems and methods of the present invention for connecting healthcare organizations with vendors for the purpose of matching healthcare professionals with healthcare organizations on a temporary basis;

FIG. 2 depicts a schematic of an exemplary hospital administrator (or other healthcare facility person) and an exemplary vendor (also referred to herein as a “bidder” or an “agency”) and their use of possible method steps for connecting healthcare organizations with vendors for the purpose of matching healthcare professionals with healthcare organizations on a temporary basis via the secure web-based system of the present invention;

FIG. 3 depicts an exemplary screenshot for logging in to the secure web-based system of the present invention;

FIG. 4 depicts an exemplary “main” or “home” screenshot for creating, reviewing, and managing open (new), pending, active, past, lost, and cancelled assignments using the secure web-based system of the present invention;

FIG. 5 depicts an exemplary “Open” assignment screenshot for viewing new assignments, which do not have an accepted bid using the secure web-based system of the present invention;

FIG. 6 depicts an exemplary screenshot for editing a new assignment, i.e., prior to submitting the new assignment to one or more vendors using the secure web-based system of the present invention;

FIG. 7 depicts an exemplary screenshot for submitting a new assignment to one or more vendors using the secure web-based system of the present invention;

FIG. 8 depicts an exemplary screenshot for creating a new assignment that is to be sent to one or more vendors using the secure web-based system of the present invention;

FIG. 9 depicts an exemplary “Open” assignment screenshot for viewing new assignments, which have not been submitted for bid yet using the secure web-based system of the present invention;

FIG. 10 depicts an exemplary “Cancel” assignment screenshot for cancelling an assignment using the secure web-based system of the present invention;

FIG. 11 depicts an exemplary “Bids” screenshot for viewing details of a given bid using the secure web-based system of the present invention;

FIG. 12 depicts an exemplary “Bid Accept/Decline” screenshot for accepting or declining a given bid using the secure web-based system of the present invention;

FIG. 13 depicts the exemplary “Bid Accept/Decline” screenshot of FIG. 12, wherein a hospital administrator has accepted the bid using the hospital administrator's user name and password for verification purposes in the secure web-based system of the present invention;

FIG. 14 depicts an exemplary “Pending” assignment screenshot for viewing details of pending assignments using the secure web-based system of the present invention;

FIG. 15 depicts an exemplary “Assignment Details” screenshot for viewing details of a given assignment using the secure web-based system of the present invention;

FIG. 16 depicts an exemplary “Active” assignment screenshot for viewing details of active assignments using the secure web-based system of the present invention;

FIG. 17 depicts an exemplary “Past” assignment screenshot for viewing details of past (i.e., completed) assignments using the secure web-based system of the present invention;

FIG. 18 depicts a portion of an exemplary “Past” assignment screenshot for leaving feedback for a vendor using the secure web-based system of the present invention;

FIG. 19 depicts an exemplary “Leave Feedback” screenshot for use by a hospital administrator so as to leave detailed feedback for a vendor using the secure web-based system of the present invention;

FIG. 20 depicts an exemplary “Canceled” assignment screenshot used in the secure web-based system of the present invention;

FIG. 21 depicts an exemplary “Messages” screenshot used in the secure web-based system of the present invention;

FIG. 22 depicts an exemplary “Reports” screenshot used in the secure web-based system of the present invention;

FIG. 23 depicts an exemplary “Create Bid” section of a “Bids” screenshot used in the secure web-based system of the present invention;

FIG. 24 depicts an exemplary “Create Bid” screenshot that shows detailed fields for a given bid used in the secure web-based system of the present invention;

FIG. 25 depicts an exemplary “Confirm Assignment” section of an “Assignment—Pending” screenshot used in the secure web-based system of the present invention;

FIG. 26 depicts an exemplary “Confirmation Agreement” screenshot used in the secure web-based system of the present invention;

FIG. 27 depicts an exemplary section of an “Assignment Detail” screenshot that may be used in the secure web-based system of the present invention to add vendor documents and related threads, and respond to a given thread;

FIG. 28 depicts an exemplary “Thread: Potential Provider” screenshot that may be used in the secure web-based system of the present invention to respond to a given thread or message;

FIG. 29 depicts a portion of an exemplary “Past” assignment screenshot for leaving feedback for a healthcare organization (HCO) using the secure web-based system of the present invention; and

FIG. 30 depicts an exemplary section of an “Assignment Lost” screenshot that may be used in the secure web-based system of the present invention to view assignments that were not awarded to a given vendor.

### DETAILED DESCRIPTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

The present invention is directed to methods of connecting healthcare organizations and vendors for the purpose of matching a healthcare professional with a healthcare organization on a temporary basis using a secure web-based system. The present invention is further directed to computing systems capable of performing the disclosed methods for connecting healthcare organizations and vendors for the purpose of matching a healthcare professional with a healthcare organization on a temporary basis. The present invention is even further directed to computing systems comprising at least one device operatively adapted to access a secure web-based system and utilize one or more of the disclosed methods for connecting healthcare organizations and vendors for the purpose of matching a healthcare professional with a healthcare organization on a temporary basis.

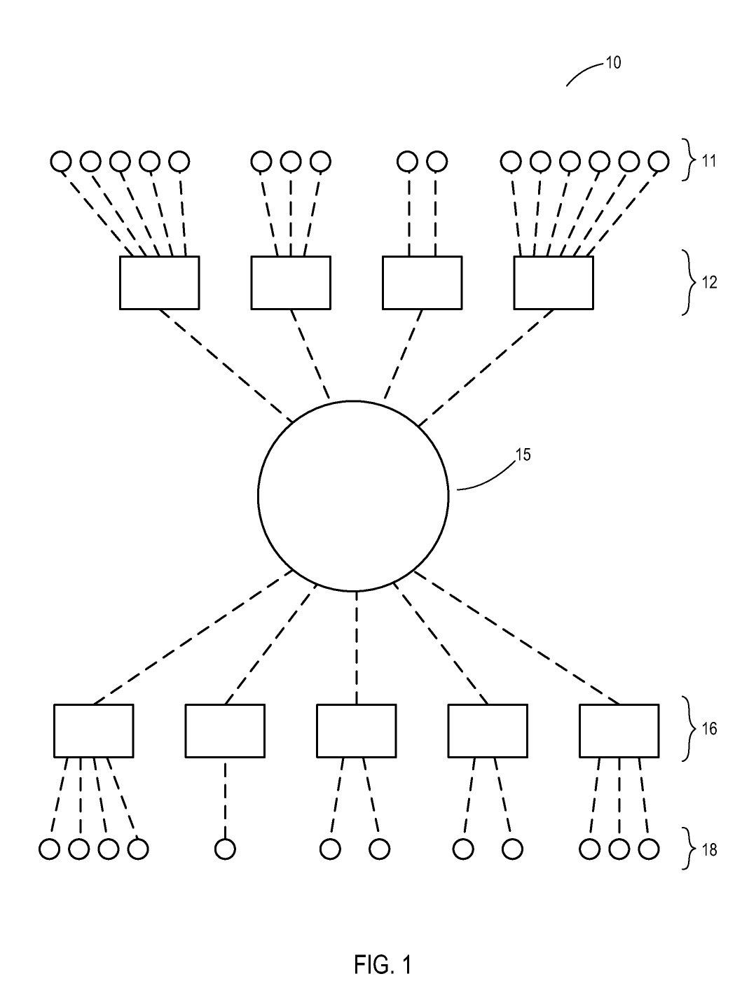

FIG. 1 depicts a schematic of exemplary participants utilizing the secure web-based systems and methods for connecting healthcare organizations and vendors for the purpose of matching a healthcare professional with a healthcare organization on a temporary basis of the present invention. As shown in FIG. 1, a number of healthcare organizations (HCOs) 16, each independently comprising one or more healthcare facilities 11 (e.g., a hospital, clinic, etc.), interact with a secure web-based system/program 15 so as to facilitate placement of a given healthcare professional 18 in a temporary assignment at a given healthcare facility 11 within a given healthcare organization 16. Further, as shown in FIG. 1, a number of vendors/bidders/agencies 16, each independently representing one or more healthcare professionals 18 (e.g., a physician, nurse, or other healthcare provider), also interact with secure web-based system/program 15 to also facilitate placement of a given healthcare professional 18 in a temporary assignment at a given healthcare facility 11 within a given healthcare organization 16. As discussed below, secure web-based system/program 15 of the present invention enables placement of multiple healthcare professionals 18 in multiple temporary assignments at multiple healthcare facilities 11 within multiple healthcare organizations 16. Further, as discussed below, secure web-based system/program 15 of the present invention provides a clear record of all transactions necessary for placement of multiple healthcare professionals 18 in multiple temporary assignments at multiple healthcare facilities 11, as well as a clear record of past assignments and relationships between each healthcare professional 18, represented by a given vendor/bidder/agency 16, and each healthcare facility 11 for each active and past assignment.

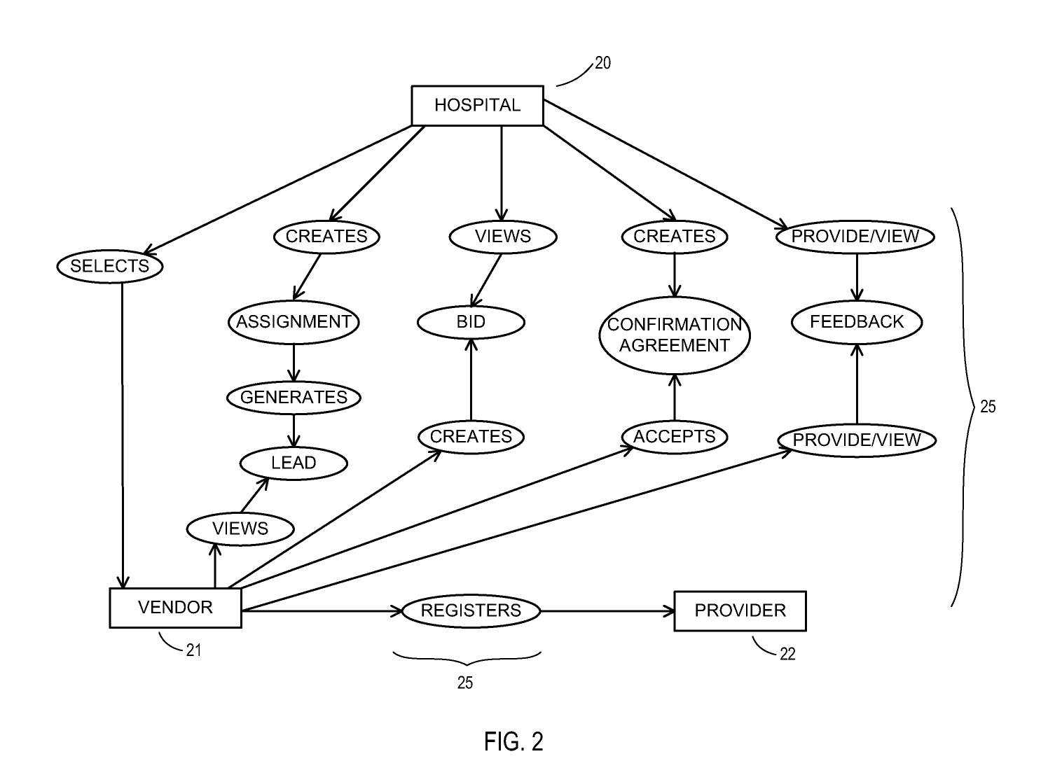

FIG. 2 depicts a schematic of an exemplary hospital administrator (or other healthcare facility person) and an exemplary vendor (also referred to herein as a “bidder” or an “agency”) and their use of possible method steps for connecting healthcare organizations and vendors for the purpose of matching a healthcare professional with a healthcare organization on a temporary basis via the secure web-based system of the present invention. As shown in FIG. 2, exemplary hospital administrator (or other healthcare facility person) 20 and exemplary vendor (also referred to herein as a “bidder” or an “agency”) 21 may perform a number a tasks 25 so as to match a healthcare professional (e.g., provider 22) with a facility of a healthcare organization on a temporary basis via the secure web-based system of the present invention. Exemplary vendor 21 may perform one or more additional tasks 25 in order to register/add provider 22 in the secure web-based system of the present invention.

As shown in FIG. 2, the systems and methods of the present invention enable exemplary hospital administrator 21 to perform a number of tasks relating to the creation and management of assignments for temporary healthcare provider services. Tasks that may be performed by each hospital administrator (or other hospital personnel or other healthcare facility personnel) include, but are not limited to, creating and awarding a new assignment for temporary healthcare provider services; managing the transition of an awarded (i.e., pending) assignment to an active assignment; managing the details of an active assignment; and managing the aspects of a past assignment.

The task of creating and awarding a new assignment for temporary healthcare provider services may include a number of method steps performed by the hospital administrator (or other hospital personnel or other healthcare facility personnel). Suitable method steps that may be performed by the hospital administrator (or other hospital personnel or other healthcare facility personnel) when creating and awarding a new assignment for temporary healthcare provider services may include, but are not limited to, accessing a web-based program for connecting healthcare organizations and vendors for the purpose of matching a healthcare professional with a healthcare organization on a temporary basis by using a user name and password; providing assignment details that may be viewable by one or more potential bidders for the assignment; saving the new assignment using the web-based system; submitting the new assignment to one or more select vendors (e.g., professional healthcare recruiting agencies) from a list of possible vendors (e.g., vendors that are a part of the electronic master agreement); reviewing bids from one or more vendors/bidders including bid details (e.g., bid rates) by clicking on individual bid numbers assigned to each bid; reviewing details of the potential healthcare provider (e.g., the provider's CV, references, copies of certifications and licenses, and employment eligibility verification) typically by clicking on the provider's name provided by the vendor/bidder; accepting or rejecting a given bid by clicking on a given bid number; for the winning bid, inputting a user name and password into designated fields within the winning bid details associated with the winning bid number; creating an electronic Confirmation Agreement, a legal document that is a part of and operates under the terms of the master agreement between the vendor and the healthcare organization; providing notice of acceptance of a winning bid (as well as notice of a declined bid) to a vendor/bidder via the web-based system.

The task of managing the transition of an awarded (i.e., pending) assignment to an active assignment may include a number of method steps performed by the hospital administrator (or other hospital personnel or other healthcare facility personnel). Suitable method steps that may be performed by the hospital administrator (or other hospital personnel or other healthcare facility personnel) when managing the transition of an awarded assignment (i.e., a pending assignment) to an active assignment may include, but are not limited to, accessing a web-based program for connecting healthcare organizations and vendors for the purpose of matching a healthcare professional with a healthcare organization on a temporary basis by using a user name and password; from an “Administration” screen, entering a “Manage Contracts” screen; viewing a master agreement and any addendums for the vendor/bidder; determining which documents are required for a given assignment (e.g., a clinical requirements document, skills checklist, community description, and/or a background information check waiver form); from an “Assignments” screen, entering a “Pending” screen; clicking on the provider's name to review provider's attached documents (e.g., at a minimum, the provider's CV and 3 references); clicking on a given assignment number and viewing uploaded vendor assignment documents (e.g., the COI and documents specific to the assignment); contacting the vendor/bidder if documents are missing; on the “Pending” screen, clicking on the assignment number to view documents uploaded by the hospital administrator (or other hospital personnel or other healthcare facility personnel); uploading any missing documents (see, for example, Addendums 1-3 in Table 5 below for an exemplary list of documents); and when all documentation is verified as being complete and the provider is ready to begin work on the assignment, on the “Pending” screen, clicking on the “Move to Active” link and pressing “OK” to confirm.

The task of managing the details of an active assignment may include a number of method steps performed by the hospital administrator (or other hospital personnel or other healthcare facility personnel). Suitable method steps that may be performed by the hospital administrator (or other hospital personnel or other healthcare facility personnel) when managing the details of an active assignment may include, but are not limited to, accessing a web-based program for connecting healthcare organizations and vendors for the purpose of matching a healthcare professional with a healthcare organization on a temporary basis by using a user name and password; from an “Assignments” screen, entering an “Active” screen; extending an assignment end date by clicking on an “Extend” link on the “Active” screen, selecting a new end date, and pressing “Extend”; editing the original bid details to indicate the extension; executing a confirmation agreement for the extension; when the assignment is completed, from the “Assignments” “Active” screen, clicking on the “Move to Past” link, and pressing “OK” to confirm.

The task of managing the aspects of a past assignment may include a number of method steps performed by the hospital administrator (or other hospital personnel or other healthcare facility personnel). Suitable method steps that may be performed by the hospital administrator (or other hospital personnel or other healthcare facility personnel) when managing the aspects of a past assignment may include, but are not limited to, accessing a web-based program for connecting healthcare organizations and vendors for the purpose of matching a healthcare professional with a healthcare organization on a temporary basis by using a user name and password; from the “Assignments” screen, entering the “Past” screen; clicking on the “Leave Feedback” link on the “Past” screen; assigning an overall assignment feedback score, for example, a feedback score ranging from 1 (low) to 5 (high); adding detailed comments regarding the assignment and provider in a “Feedback” section so the vendor/bidder knows what the hospital administrator (or other hospital personnel or other healthcare facility personnel) liked/disliked; saving any feedback by pressing “Save”; editing the feedback for a period of time, for example, up to 2 months, after the end date on the confirmation agreement; viewing feedback provided by the vendor and/or provider by clicking on a given assignment number in a “Vendor Feedback Score” column on the “Past” screen; and reviewing an overall feedback assignment score and comments from the vendor/bidder and/or provider.

The systems and methods of the present invention enable each vendor/bidder (e.g., exemplary vendor 21) to perform a number of tasks relating to the process of matching a given healthcare provider with a given assignment for temporary healthcare provider services. Tasks that may be performed by a vendor/bidder include, but are not limited to, reviewing one or more assignments, for example, by choosing the website option “Open Assignments” from the control panel on the “Assignments Overview” webpage, clicking on a provided assignment number to view details about a given assignment; reviewing uploaded documents and/or messages (e.g., documents uploaded and/or messages by the hospital administrator); adding a new provider for consideration for a given assignment, for example, by clicking on the “Add Provider” link on the “Manage Providers” screen accessed from an “Administration” screen; inputting provider details; uploading a provider's CV, references and any other documentation for the provider (e.g., the national provider identifier (NPI) number of the provider); and in response to receiving a request to bid on one or more assignments from a hospital administrator, submitting a bid for the one or more assignments, for example, by entering the “Assignments” screen, selecting the “Open” screen option, pressing the “Bids” option to the right of a given assignment in a listing of assignments, clicking on the “Create Bid” link, filling in bid details, entering rates (e.g., as numbers only), and pressing the “Save” option.

The vendor/bidder may also perform a number of tasks relating to a received notification of a declined bid. Suitable tasks include, but are not limited to, reviewing one or more declined bids; determining why a given bid was declined by pressing the “Bids” link to the right of the assignment listing, and clicking on the bid number to view the “Declined Reason” field of the bid; based on the content within the “Declined Reason” field, determining whether to submit a revised bid; optionally submitting a new bid.

The vendor/bidder may further perform a number of tasks relating to a received notification of an accepted bid. Suitable tasks include, but are not limited to, reviewing any assignments on the vendor/bidder's “Pending” screen, which indicates that a bid for the displayed assignment was selected; signing a confirmation agreement by clicking on a “Confirm” link in a “Confirmed by Vendor” column on the vendor/bidder's “Pending” screen, typing in the vendor/bidder's name in a “Signature field”, entering the vendor/bidder's password in the “password” field, and pressing “Confirm”; viewing a master agreement and any addendums by accessing the “Manage Contracts” screen from the “Administration” screen; determining which documents the vendor/bidder is required to provide for the awarded assignment; reviewing documents uploaded for a given provider by going to the “Assignments” screen, then the “Pending” screen, and clicking on the provider's name; and uploading documents, as needed, for a given provider (e.g., the provider's CV, three references, the provider's NPI number, etc.) by clicking on a given assignment number and uploading documents to the “Vendor Documents” field (also may include COI and assignment documents noted in Addendums 1-3, Table 5 below).

The vendor/bidder may further perform a number of tasks relating to active assignments (i.e., assignments that are ready to start). Suitable tasks include, but are not limited to, reviewing the “Active” assignment screen to view assignments that the hospital administrator has determined to be complete, namely, that all documentation is complete and the provider is ready to begin work; reviewing a new assignment on the “Open” screen in response to receiving notification that the hospital administrator wishes to extend an end date of given active assignment; and if accepting the extension, completing a new workflow assignment and executing a confirmation agreement for the extension.

The vendor/bidder may even further perform a number of tasks relating to completed/past assignments. Suitable tasks include, but are not limited to, reviewing the “Past” assignment screen to view completed/past assignments that the hospital administrator has determined to be completed; leaving feedback for the hospital administrator by clicking on the “Leave Feedback” link; assigning an overall score, for example, a score of 1 (low) to 5 (high); adding detailed comments into the “Feedback” section so the hospital administrator knows what the vendor/bidder liked/disliked, and pressing the “Save” option; editing any vendor/bidder provided feedback for a period of time, typically, for up to about two months after the end date on a given confirmation agreement; viewing feedback provided by the hospital administrator for a given completed assignment by clicking on the assignment number of the completed assignment in the “HCO Feedback Score” column; and reviewing overall feedback assignment score and HCO comments for a given completed assignment.

The systems and methods of the present invention may utilize a master locum tenens agreement (LTA) that can be used by all participants (e.g., hospitals and vendors). The master LTA may have one or more of the following components/features: covers all specialties; covers all facilities within a given healthcare organization (HCO); includes all agencies (i.e., vendors); automatically renews; comprises no rate sheets; indicates quality standards (e.g. that medical malpractice insurance is provided by the agency at particular limits); provides a cancellation period; provides a procuring cause period for candidate presentations; requires provider documentation including, but not limited to, the provider's CV, references, copies of certifications and licenses, and employment eligibility verification; provides coverage requests (i.e., assignments) and presentations (i.e., bids) through the LocumsMart portal; enables confirmation agreements to be signed and stored electronically; and provides for set permanent placement fees (e.g., $18,000—Mid-levels; $20,000—CRNAs; $22,000—Family Practice, Internal Medicine, Pediatrics and Psychiatry; and $25,000—all other specialties).

The present invention is further directed to computing systems capable of performing the disclosed methods for connecting healthcare organizations and vendors for the purpose of matching a healthcare professional with a healthcare organization on a temporary basis. Typically, a given computing system comprises at least one application or program usable on the computing system, wherein the at least one application or program comprises application code loaded thereon for performing one or more of the disclosed methods for connecting healthcare organizations and vendors for the purpose of matching a healthcare professional with a healthcare organization on a temporary basis. For example, a server may be used to run application code for performing one or more of the disclosed methods for connecting healthcare organizations and vendors for the purpose of matching a healthcare professional with a healthcare organization on a temporary basis with the server being connected to a computing system that is accessible from a variety of devices.

The present invention is even further directed to computing systems comprising at least one device operatively adapted to access a secure web-based system and utilize one or more of the disclosed methods for connecting healthcare organizations and vendors for the purpose of matching a healthcare professional with a healthcare organization on a temporary basis. Desirably, a given computing system comprises at least one device operatively adapted to access the secure web-based system and utilize one or more of the disclosed methods for connecting healthcare organizations and vendors for the purpose of matching a healthcare professional with a healthcare organization on a temporary basis so as to facilitate reaching an accepted match between (1) a specific healthcare provider and (2) a specific facility of a healthcare organization for a temporary assignment performed by the specific healthcare provider at the specific facility, as well as the electronic execution of a master agreement and any addendums to the master agreement via the secure web-based system so as to form a contractual agreement between (1) the specific vendor and (2) the specific facility of the healthcare organization for the temporary assignment to be performed by a specific healthcare provider at the specific facility.

A variety of devices may be used to access a secure web-based system and utilize one or more of the disclosed methods for connecting healthcare organizations and vendors for the purpose of matching a healthcare professional with a healthcare organization on a temporary basis. Suitable devices include, but are not limited to, personal computers, server computers, hand-held or laptop devices (e.g., computers, smart phones, notepads, or any other device with Internet access), multiprocessor systems, microprocessor-based systems, set top boxes, programmable consumer electronics, network PCs, minicomputers, mainframe computers, distributed computing environments that include any of the above systems or devices, and the like.

The systems and methods of the present invention enable the efficient, cost-effective matching of connecting healthcare organizations and vendors for the purpose of healthcare providers with healthcare organizations on a temporary basis while providing a clear, transparent record of the business relationship. The systems and methods of the present invention provide the following benefits over prior methods of matching healthcare providers with healthcare organizations on a temporary employment basis:

the ability to lower overall costs for the HCOs and vendors;

the ability to lower healthcare organizations' costs in at least three ways:
1) reduced labor expenses due to a decrease in the amount of time the healthcare organizations' employees spend on the locum tenens process;
2) reduced locum tenens coverage rates due to agencies passing on a portion of their savings from increased efficiency; and
3) increased transparency, and access to data, should help healthcare organizations reduce costs through the establishment of best practices;

increased access to objective and transparent data, the ability to calculate ROI, and the adoption of enhanced best practices across a healthcare system—not to mention lower rates and a less labor-intensive process;

reducing the time-intensive and laborious workflow steps relating to the contracting process between agencies and healthcare organizations;

bring transparency where it lacked due to prior methods utilizing phone and paper-driven processes;

the ability to run quick, accurate reports with objective data about past, current, or future contracts;

eliminate the need to negotiate a new contract from scratch for each new assignment;

the ability to have a master contract that renews automatically;

the ability to guarantee that all assignments have a signed contract in place;

the ability to have contracts signed on a “corporate” level so as to apply to all facilities within a healthcare organization's system, as well as all specialties for which an agency recruits;

the ability to reduce paperwork and associated labor costs for all parties;

the ability to greatly improve the transparency of the process due to the increased ease of reporting data off of digital documents instead of paper;

the ability to increase transparency and data reporting, which allows healthcare organizations to determine best practices and make locum tenens purchases with accurate ROI predictions;

the ability to eliminate the need for a healthcare organization to contact individual vendors/agencies separately when a given assignment is filled; and

the ability to reduce the amount of time and resources that a healthcare organization and/or vendor/agency spend on marketing, and instead spend more time and resources on recruiting, which in turn will result in higher lead conversion rates.

The systems and methods of the present invention may also be utilized to provide automatic procuring cause protection, wherein an agencies' procuring cause status over one or more providers that the agency presents to hospitals is automatically enforced according to the terms of a master contract between the HCO and the agency. For example, if a contract gives 12 months of procuring cause protection over bids from an agency, then after Agency X presents Dr. Y to Hospital Z, no other Agency will be able to present Dr. Y to Hospital Z for the next 365 days. This may be accomplished by omitting Dr. Y from every vendor's provider drop-down menu on the “Create Bid” screen (discussed in the Example below), except Agency X, and only for bids to be submitted to Hospital Z. After 365 days have passed, all agencies that have a provider record for Dr. Y will be able to view Dr. Y on their provider drop-down menu on the “Create Bid” screen when trying to submit a bid to Hospital Z, at least until an agency actually does submit a bid to Hospital Z that includes Dr. Y, and at that point the process would repeat with the presenting agency being the only one that can present Dr. Y for the next 365 days.

The systems and methods of the present invention may also be utilized to indicate the availability of a given provider for a given hospital. The systems and methods of the present invention make the presentation process transparent by showing who (i.e., a given agency) has ownership of a provider, where, and for how long. The system and methods allows hospitals to see when they can hire which providers and at what facilities without paying permanent recruitment fees. Further, the systems and methods of the present invention allow agencies to more easily challenge unethical presentations, and give them objective evidence to back up their claims.

The present invention is described above and further illustrated below by way of examples, which are not to be construed in any way as imposing limitations upon the scope of the invention. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example

The example below provides a description of actual steps that users (i.e., one or more hospital administrators, one or more vendors, one or more system administrators (e.g., LocumsMart employees, IT experts, etc.)) may take to perform one or more functions using the secure web-based system of the present invention.

A short list of frequent abbreviations used in this example:

HCO=healthcare organization [also referred to as the client]

Provider=medical professional that is recommended by the vendor for an assignment

Agreement=Contract (and vice versa)

Vendor=Recruiting Agency (and vice versa)

### Logging in:

A user logs in using the following steps:

1. Open a web browser to: https://www.locumsmart.net/. A screenshot similar to the one shown in FIG. 3 will appear.

2. Type your “User Name” in the “User Name” field.

3. Type your “Password” in the “Password” field.

4. Press the “Log In” or “Submit” button (depending on the login screen). Locumsmart.net will open on the screen.

The secure web-based system of the present invention provides special instructions for logging in for the first time, as well as forgotten user names and/or passwords.

### Assignment—Overview:

The Assignments page is the “Main” or “Home” navigation screen. An exemplary Assignments page is shown in FIG. 4. Table 1 below provides a description of various features accessible from the Assignments page.

TABLE 1
Various Features Accessible from the Assignments Page.

| Field Name | Description |
|---|---|
| Search box and | Used to search the locumsmart.net site. Use the search box at the top of |
| button: | each screen to search for assignment information stored in |
| | LocumsMart. Sample searches might include: locating all reference |
| | to a Provider's name (ex. “Jones”), finding assignments with a |
| | certain specialty or facility (“hospitalist”), finding assignments by |
| | assignment number (“63374131659-06200”), or locating key words |
| | (“Memorial Hospital”) in a message. Similar to a Google search but |
| | the results are focused on information within LocumsMart. |
| Welcome | Greets you by name and date. Please log out if you do not see your |
| Information: | name in this greeting. |
| Tab Bar: | Clicking on the Tabs (assignments, messages, reports, |
| | administration, help, & about us) in the blue bar will navigate you to |
| | other sections within the site. Note: It will also change the options |
| | available to you in the Dialogue (gray) bar below. Use the Tab Bar |
| | to move among the different categories. |
| Dialogue Bar: | Clicking on the titles (overview, open, pending, active, past) in the |
| | gray bar will open different sections of the website. |
| Control Panel: | Provides a short cut to view or locate work that is already in |
| | progress. |
| Get Started: | Provides a short cut to view reference materials or open |
| | LocumsMart's reports section. |
| Report 1 & | Customizable to show you your two favorite reports. Updated |
| Report 2: | automatically when you open or refresh this page (after 9/1). (See |
| | the Reports section of the Guide to learn how to add a report to your |
| | view). |
| Terms of Use: | Details the agreement between you and LocumsMart for site use. |
| Privacy Policy: | Details how information obtained from this site will be used by |
| | LocumsMart. |

Clicking on any of the links on the Assignments page will open the section selected. For example, new assignments are created using the “Create Assignment” link found on the Assignment screen as shown in FIG. 4 (right-hand side under “Get Started”).

Assignment—Open:

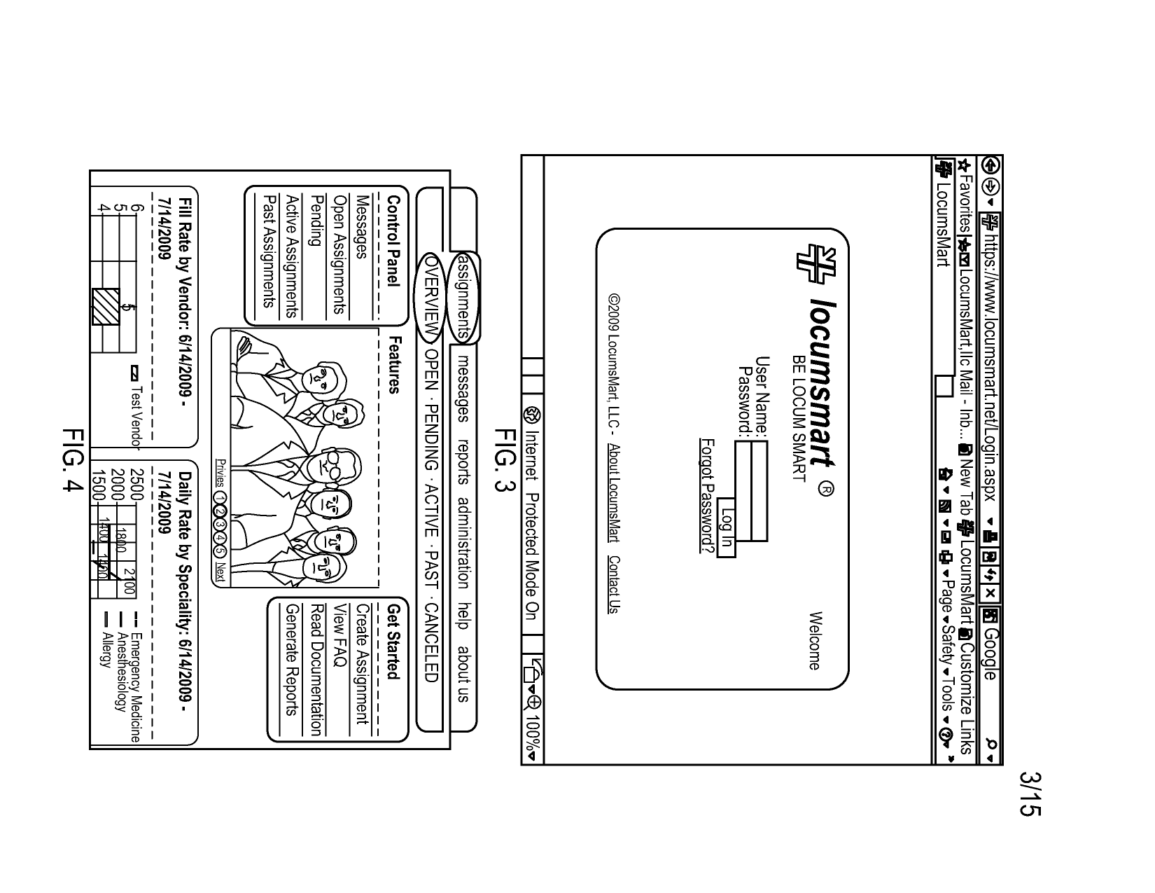

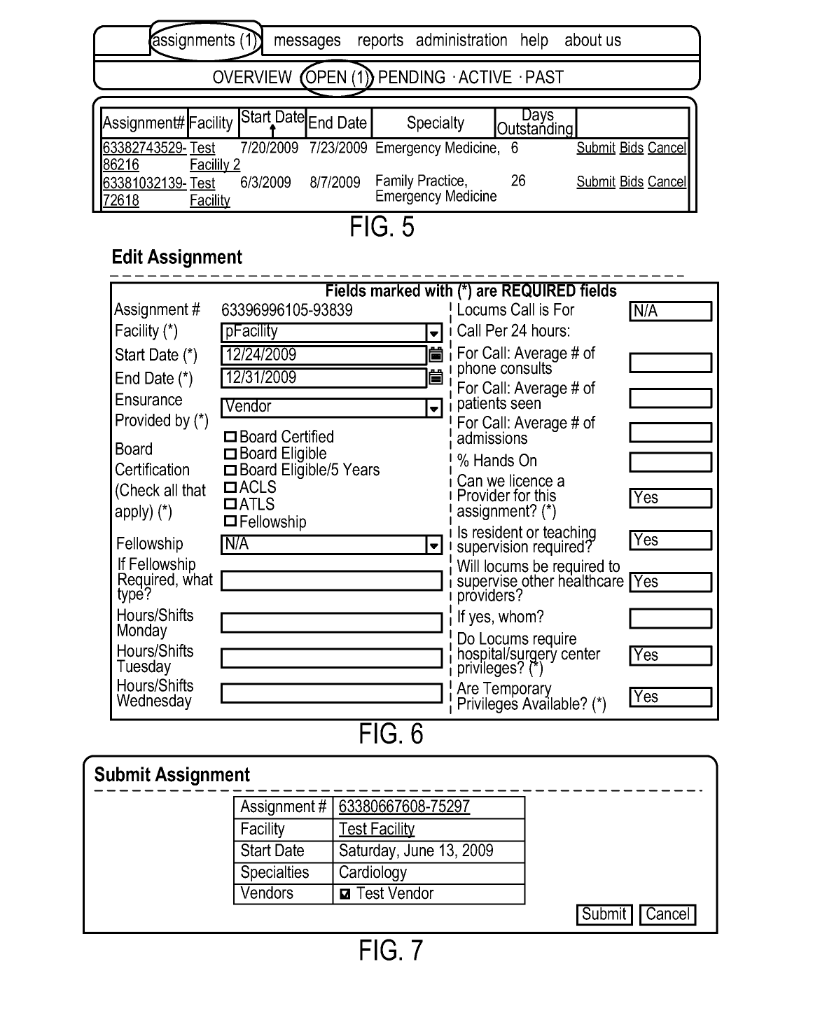

Newly created assignments are listed on the “Open” assignment page, shown in FIG. 5, until a bid is accepted, and both parties agree to the terms of the electronic confirmation agreement. The word “Bids” appears in bold (and the count of new bids is reflected next to the Assignments and Open tabs) until viewed for the first time by a user with a role of Recruiter or Manager.

The “Open” assignment page includes the following fields shown in Table 2 below.

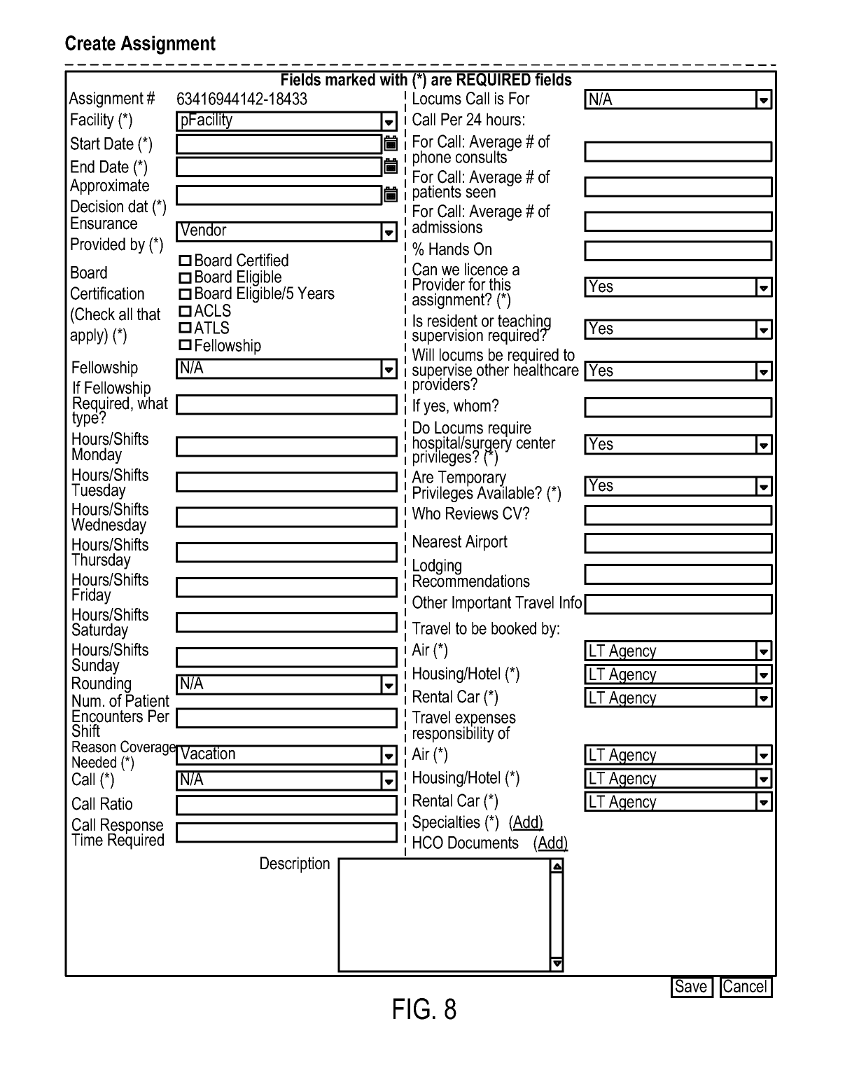

TABLE 2
Open Assignment Page Features

| Field Name | Description |
|---|---|
| Assignment #: | locumsmart.net generated number to identify the assignment. |
| | Clicking on the assignment number will open the Edit Assignment |
| | screen (shown as FIG. 6) |
| Facility: | Name of the location where the assignment is to be worked and where |
| | the provider is needed. |
| | Clicking on the facility name will open the Facility Details screen (not |
| | shown) and show you address and contact information. |
| Start Date: | The realistic intended start date for the assignment. |
| End Date: | The realistic completion (end date) for the assignment. |
| Specialty: | One or more provider specialties that you (the HCO) have indicated |
| | will be accepted for the assignment. |
| Days | The number of days since the bid was first posted by the HCO (you or |
| Outstanding: | other team members). |
| Submit: | Used to identify which vendors you wish to send the assignment to |
| | and to submit the assignment to the vendors for their bid(s). |
| | Clicking on “Submit” will open the Submit Assignment screen in your |
| | browser (shown as FIG. 7). |
| Bids: | Click on the “Bids” link if you wish to view a list of any bids received |
| | for this assignment. |
| | Clicking on “Bids” will open the Bids section in your browser (shown |
| | as FIG. 10). |
| Cancel: | Click on the cancel link if you wish to cancel an assignment you have |
| | posted. |
| | Clicking on “Cancel” will open the Cancel Assignment section in your |
| | browser (not shown). |
| | Note: All cancellations are subject to the terms agreed upon in the |
| | corporate contract. |
| Create | Click on the “Create Assignment” link on the bottom left side of the |
| Assignment: | screen (under the last Assignment # field) to create a new assignment |
| | (not shown) (or use the “Create Assignment” option discussed above |
| | and as shown in FIG. 4). |
| | Clicking on “Create Assignment” will open the Create Assignment |
| | screen in your browser, shown as FIG. 8. |

### To Create an Assignment:

1. From the Assignments—Open screen, Click on the “Create Assignment” link on the bottom left side of the screen (under the last Assignment # field) (not shown).

2. The Create Assignment screen will open (FIG. 8).

3. Fill in each of the fields (fields described in Table 3 below).

4. Upload any documents that will help the Vendor better prepare a bid to meet the needs of a given assignment. Examples of HCO documents include a clinical requirements document, skills checklist, community description, and/or a background information check waiver form.

5. Press “Save”.

TABLE 3
Fields to be Filled Out on Create Assignment Screen

| Field Name | Description or Sample Content |
|---|---|
| Assignment #: | The locumsmart.net generated number used to identify the |
| | assignment. |
| Facility: | Select the name of the location where the assignment is to be |
| * required field | worked/where the provider is needed. |
| Start Date: | The first date you need a provider to work on this assignment. |
| * required field | Use the calendar button to the right of this field to select the date |
| | from the built in calendar. |
| End Date: | The last date you need a provider to work on this assignment. |
| * required field | Use the calendar button to the right of this field to select the date |
| | from the built in calendar. |
| Approximate | Used to indicate to the agencies how urgent your need is, and |
| Decision Date: | how quickly you plan to make a decision. |
| | Note: The start date is the first date the provider is expected to |
| | work. Therefore, the “Approximate Decision Date” should |
| | always come prior to the start date of the assignment. |
| Insurance Provided | Will the Vendor or the Hospital be providing the insurance for |
| By: | this assignment? Select one. |
| * required field | |
| Board Certification: | Select the minimum level of Board Certification the locums |
| * required field | provider must have obtained to work this assignment (one or |
| | multiples can be selected). Click in each box to select that |
| | requirement. |
| Fellowship: | Is a Fellowship Preferred, Required, or Not Applicable? Select |
| | one. |
| If Fellowship | If a Fellowship is required, use this free form text field to |
| Required, what type? | indicate specific details about the level of fellowship training |
| | required. |
| Hours/Shifts Monday: | Use this free form text field to indicate likely hours for Monday |
| | coverage. Ex. 7 AM-4 PM |
| Hours/Shifts | Use this free form text field to indicate likely hours for Tuesday |
| Tuesday: | coverage. Ex. 7 AM-4 PM |
| Hours/Shifts | Use this free form text field to indicate likely hours for |
| Wednesday: | Wednesday coverage. Ex. 7 AM-4 PM |
| Hours/Shifts | Use this free form text field to indicate likely hours for Thursday |
| Thursday: | coverage. Ex. 7 AM-4 PM |
| Hours/Shifts Friday: | Use this free form text field to indicate likely hours for Friday |
| | coverage. Ex. 7 AM-4 PM |
| Hours/Shifts | Use this free form text field to indicate likely hours for Saturday |
| Saturday: | coverage. Ex. 7 AM-4 PM |
| Hours/Shifts Sunday: | Use this free form text field to indicate likely hours for Sunday |
| | coverage. Ex. 7 AM-4 PM |
| Rounding: | Select N/A; AM; PM; or Both to indicate when the locums |
| | provider will be expected to make rounds. |
| Number of Patient | Use this free form text field to indicate the approximate number |
| Encounters Per Shift: | of patient encounters per shift. |
| | Ex. 7/shift; 15-20/shift; Inpatient: 2/Outpatient: 7 |
| Reason Coverage | Is the locum provider needed to cover: Vacation, Extra Volume, |
| Needed: | Vacancy, Supplemental, Call, or Other? Select one. |
| * required field | |
| Call: | What are the call requirements for this job? N/A, In-House, |
| * required field | Beeper, or 2nd call/backup? Select one. |
| Call Ratio: | Indicate an estimated call ratio. Example: Call 1/3 |
| Call Response Time | What are the expectations for how quickly the provider should |
| Required: | respond? |
| Locums Call is For: | Indicate whether call is for: N/A, Assigned Patients, Unassigned |
| | Patients, or Both. |
| Call Per 24 Hours: | (intentionally left blank) |
| For Call: Average # | Estimate of the average number of phone consults the locums |
| of phone consults | provider can expect during call. Ex. 2 consults. |
| For Call: Average # | Estimate of the average number of patients seen during call. Ex. |
| of patients seen | 0-1 patients. |
| For Call: Average # | Estimate of the average number of admissions the locums |
| of admissions | provider can expect during call. Ex. 1 admission. |
| % Hands On: | Estimate of percentage of Call that requires patient contact. |
| Can we license a | Select Yes or No to indicate whether the vendor may license a |
| Provider for this | provider for this assignment. |
| assignment? | |
| * required field | |
| Is resident or teaching | Select Yes or No. |
| supervision required? | |
| Will locums be | Select Yes or No. |
| required to supervise | |
| other healthcare | |
| providers? | |
| If yes, whom? | Use this free form text field to indicate the titles and/or roles of |
| | other healthcare providers that the locum will supervise. Ex. |
| | Residents, Fellows |
| Do Locums require | Select Yes or No. |
| hospital/surgery | |
| center privileges? | |
| * required field | |
| Are temporary | Select Yes or No. |
| privileges available? | |
| * required field | |
| Who reviews CV? | The name and/or title of the person who will evaluate the |
| | candidate's CV. |
| Nearest Airport: | Use this free form text field to indicate which airport you would |
| | suggest that the provider fly in/out of when traveling to the |
| | facility. |
| Lodging | Use this free form text field to indicate which hotel (or other |
| Recommendations: | housing option) you recommend for this assignment. Make sure |
| | to list the hotel chain name if your facility has a special discount |
| | pricing arrangement that should be used. |
| Other Important | Use this free form text field to add other travel-related notes to |
| Travel Info | the assignment information. |
| Travel to be booked | (intentionally left blank) |
| by: | |
| Air: | Who will make the air travel arrangements: Vendor (LT |
| * required field | Agency), Client (HCO), or Not Applicable (N/A)? |
| Housing/Hotel: | Who will make the housing arrangements: Vendor (LT Agency), |
| * required field | Client (HCO), or Not Applicable (N/A)? |
| Rental car: | Who will make the rental car arrangements: Vendor (LT |
| * required field | Agency), Client (HCO), or Not Applicable (N/A)? |
| Travel expenses | (intentionally left blank) |
| responsibility of: | |
| Air: | Which party will ultimately pay for air travel expense? (Is air |
| * required field | travel billable?) Select: Vendor (LT Agency), Client (HCO), or |
| | Not Applicable (N/A). |
| Housing/Hotel: | Which party will ultimately pay for housing expense? (Is |
| * required field | housing billable?) Select: Vendor (LT Agency), Client (HCO), |
| | or Not Applicable (N/A). |
| Rental car: | Which party will ultimately pay for rental car expense? (Is rental |
| * required field | car expense billable?) Select: Vendor (LT Agency), Client |
| | (HCO), or Not Applicable (N/A). |
| Specialties: | Select the provider specialties that are acceptable for this |
| | assignment. (Note: Vendors will not be able to present providers |
| | unless the provider's specialty matches the Open Assignment |
| | request. Be sure to add ALL specialties you are willing to |
| | accept.) |
| | Press the “Add” link to add a new row. |
| | Choose the specialty from the drop down box. |
| | Repeat to add additional specialties. |
| | If you add an extra row or a specialty you wish to remove, press |
| | the “Delete” link. |
| HCO Documents: | Use to upload documents that will help the Vendor better prepare |
| | a bid to meet the needs of your assignment. Sample Documents: |
| | clinical requirements document, skills checklist, community |
| | description, and/or a background information check waiver form. |
| | Press the “Add” link to add a new row. |
| | Then press the “Browse” button to locate the document on your |
| | computer. |
| | Follow the prompts to upload/attach the document to the |
| | assignment. (Note: Documents must be under 10 mb in size.) |
| | The document will be uploaded when you press Save. |
| | If you add an extra row that you wish to remove, press the Delete |
| | link. |
| Related Thread: | Use when you have a question or comment about the assignment |
| | and you would like for all vendors (who were sent the |
| | assignment) to see the discussion. |
| | Related Threads are attached to assignment records, and any |
| | LocumsMart user that has access to the assignment can see the |
| | Related Threads. As a result, Related Threads should be used |
| | only for generic communication about an assignment that is |
| | public in nature or for comments that you wish all eligible |
| | vendors to see. |
| | (Note: Messages between you and (for example) one vendor |
| | should be handled by opening a thread directly with one or more |
| | users from the Messages tab.) |
| | Press the “Add” link to the right of the Related Threads field. |
| | Press “Ok” to acknowledge the message. |
| | On the next screen, enter a subject for your message, the text of |
| | your message, and upload any relevant documents. |
| | Press “Save”. |
| | Your Related Thread is now posted and anyone with access to |
| | see the assignment will be able to view the thread. |
| Description: | Use this field to share additional information about the |
| | assignment that the vendor will need to prepare a bid. |
| | Consider including notes about important assignment details that |
| | have not already been covered in your responses in the other |
| | fields. |

### To Edit an Assignment:

To edit an assignment (e.g., add or remove information in a newly created assignment) prior to submitting it to Vendors:

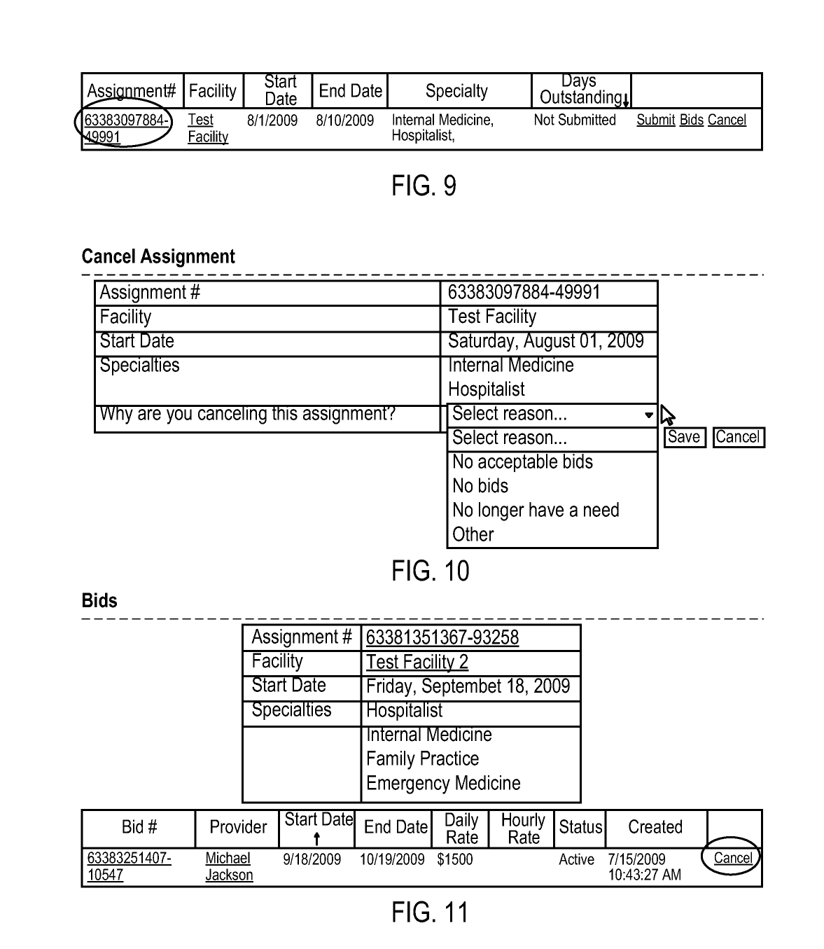

1. From the Assignments—Open screen, click on the “Assignment #” link in the first column of the assignment you wish to edit. See, FIG. 9.

2. The Edit Assignment screen will open. (See, for example, FIG. 6.) Change or add information as needed.

3. Press “Save” when done.

### To Submit an Assignment:

To submit your assignment to vendors for bids:

1. From the Assignments—Open screen (FIG. 9), click on the “Submit” link to the right of the assignment to be sent to vendor(s).

2. The Submit Assignment screen, shown as FIG. 7, will open. Place a check mark in the box(es) next to any Vendors that are to receive the assignment. Leave the box unchecked for any vendors that are not to receive the assignment.

3. Press “Submit” to send the assignment.

### To Cancel an Assignment:

To cancel an assignment previously created:

1. From the “Assignments—Open” screen (FIG. 9), click on the “Cancel” link to the right of the assignment.

2. The “Cancel Assignment” screen will open (FIG. 10). Select a reason for cancellation from the drop down box.

3. Press “Save” to cancel the assignment.

Note: All cancellations are subject to the terms agreed upon in the corporate contract.

### To View a Bid:

1. From the “Assignments—Open” screen (FIG. 9), click on the “Bids” link to the right of the assignment to view.

2. The “Bids” screen (FIG. 11) will open and a list of bids received will display.

3. To view the rates that have been bid, click on the “Bid #”.

4. To view the provider information, click on the “Provider” name.

5. To view contact information for the Vendor submitting the bid, click on the “Vendor” name.

### To Decline a Bid:

1. From the “Assignments—Open” screen (FIG. 9), click on the “Bids” link to the right of the assignment to view and decline.

2. The “Bids” screen (FIG. 11) will open and a list of bids received will display.

3. Click on the “Bid #” link for the bid to decline.

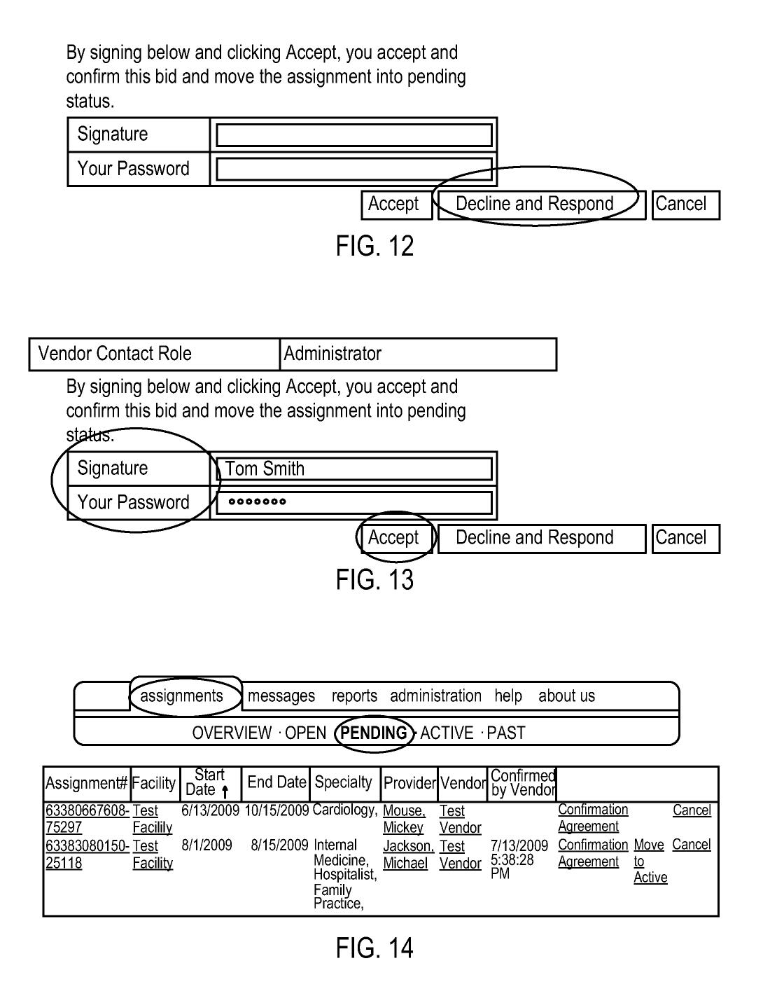

4. Scroll to the bottom of the “Accept Bid” screen (FIG. 12) and click on the “Decline and Respond” button.

5. Enter the reason for declining this bid.

6. Press “Decline”. The vendor is now automatically notified that their bid has been declined.

### To Accept a Bid and Sign a Confirmation Agreement:

1. From the “Assignments—Open” screen (FIG. 9), click on the “Bids” link to the right of the assignment to be accepted.

2. The “Bids” screen (FIG. 11) will open and a list of bids received will display.

3. Click on the “Bid #” link for the bid to be accepted.

4. Scroll to the bottom of the “Accept Bid” screen (FIG. 12) and type a personal user name in the “Signature” field and a personal LocumsMart password in the “Your Password” field.

5. Press “Accept”. The assignment is now automatically moved to the “Pending” screen.

### Assignment Pending:

By selecting the “Assignment” “Pending” link as shown in FIG. 4, a list of pending assignments is provided as shown in FIG. 14. An assignment is “Pending” after a hospital administrator signs a confirmation agreement and before the hospital administrator makes it active. While the assignment is “Pending”, the hospital administrator can wait for the Vendor to sign the confirmation agreement, for the background and credentialing information to be completed, and for all the necessary documents to be uploaded to the assignment in LocumsMart.

The pending assignment table includes the following fields:

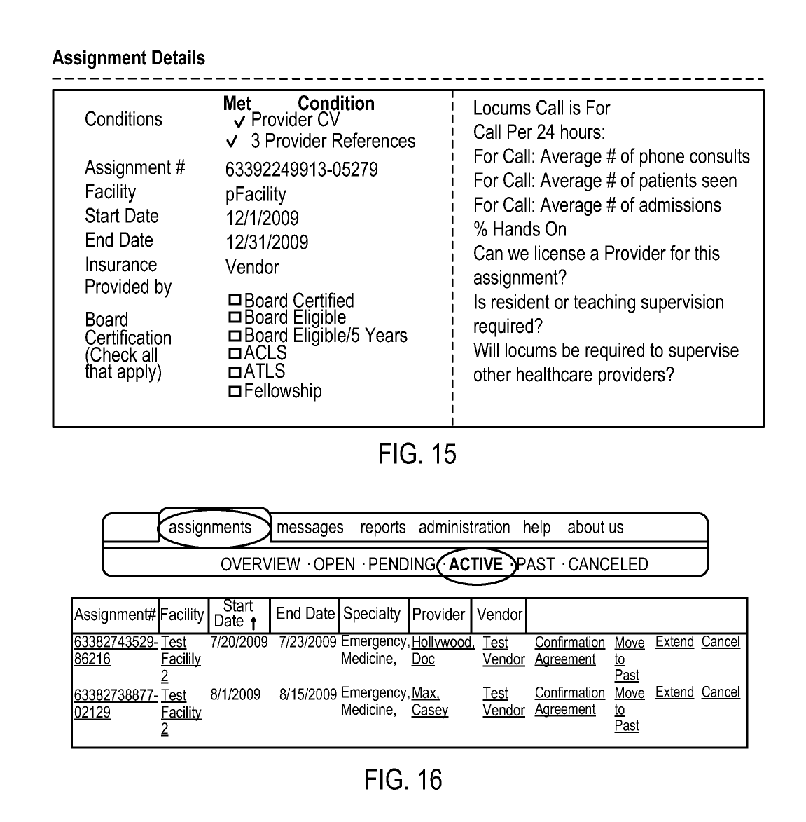

TABLE 4
Fields In a Pending Assignment Detail Screen

| Field Name | Description or Sample Content |
|---|---|
| Assignment | The locumsmart.net generated number used to identify the assignment. |
| #: | Clicking on the assignment number link will open the Assignment |
| | Details screen shown as FIG. 15. |
| Facility: | Name of the facility and location where the assignment is to be |
| | worked/where the provider is needed. |
| | Clicking on the facility name will show you contact information for the |
| | facility. |
| Start Date: | The first date the provider is available to start work on this assignment. |
| End Date: | The last date the provider is available to work on this assignment. |
| Specialty: | The required specialty(s) of the Provider needed for this assignment. |
| Provider: | The name of the provider selected for this assignment. |
| Vendor: | Name of the vendor with the winning bid. |
| | Clicking on the vendor name will show you contact information for the |
| | vendor. |
| Confirmed | Date and time that the Vendor accepted this bid and signed the |
| by Vendor: | Confirmation Agreement. If the field is blank, the Vendor has not yet |
| | signed the Confirmation Agreement. |
| Confirmation | Contains a link to the “Confirmation Agreement”. Click on the link to |
| Agreement: | view the Confirmation Agreement. |
| Move to | Once you have received and uploaded all Background Information for the |
| Active: | assignment, and the Vendor has signed the Confirmation Agreement, you |
| | can move the assignment to active status by clicking on the “Move to |
| | Active” link (shown in FIG. 14). |
| | Confirm the move by pressing “OK” when you see the verification |
| | message (not shown). Clicking “OK” on the verification link moves the |
| | Assignment from the “Pending” screen to the “Active” screen. |
| Cancel: | Click on the cancel link (shown in FIG. 14) to cancel an assignment. |
| | Note: All cancellations are subject to the terms agreed upon in the |
| | corporate contract. |
| | Clicking on “Cancel” will open the “Cancel Assignment” section in your |
| | browser (not shown). |

To determine which documents are required by a Corporate Contract, the user will need to review a HCO's Agency Locum Tenens Services Agreement with the Vendor used for the assignment. Pay special attention to the Addendums as most Addendums note required documentation. In addition, make sure the required documents are all uploaded to locumsmart.net prior to moving the assignment to “Active”.

### To Locate the Master Agreement:

1. Open the “Administration—Manage Contracts” section of locumsmart.net.

2. Click on the “View” link to the right of the master agreement to review.

3. The agreement will display on your screen.

Items mentioned in many addendums include the following shown in Table 5. (Each hospital administrator should read their agreement carefully to determine which documentation their organization requires.

TABLE 5
Typical Items Required in Master Agreements

| Addendum | Sample Documentation |
|---|---|
| Addendum 1 | Background information such as: three references, work |
| | history verification or CV, copies of current certifications |
| | and current licenses, I-9 verification, background check, |
| | health and immunization records |
| Addendum 2 | Certificate of Insurance |
| Addendum 3 | Confidentiality Agreement |
| | *You can copy and paste this text into a Word document. |
| | This makes it easier to send the Confidentiality Agreement |
| | to your Vendor so the provider can sign it prior to starting |
| | an assignment. |

### To Move an Assignment to “Active” Status:

1. From the “Assignments—Pending” section, click on the “Move to Active” link (shown in FIG. 14) for the assignment to make “Active”.

2. Confirm the move by pressing “OK” when a message appears.

3. The assignment now automatically moves from the “Pending” screen to the “Active” screen.

### Assignment Active:

When an assignment is listed on the “Active” screen (as shown in FIG. 16), the assignment is ready to be worked or is currently being worked.

The “Active” assignment table includes the following fields:

TABLE 6
Fields in Active Assignment Webpage Screen

| Field Name | Description or Sample Content |
|---|---|
| Assignment | The locumsmart.net generated number used to identify the assignment. |
| #: | Clicking on the assignment number link will open the Assignment |
| | Details screen (FIG. 15). |
| Facility: | Name of the facility and location where the assignment is being worked. |
| | Clicking on the facility name will show you contact information for the |
| | facility. |
| Start Date: | The first date the provider is available to start work on this assignment. |
| End Date: | The last date the provider is available to work on this assignment. |
| Specialty: | The required specialty(s) of the Provider needed for this assignment. |
| Provider: | The name of the provider selected for this assignment. |
| | Clicking on the provider's name will open the provider's record for you |
| | to review. |
| Vendor: | Name of the vendor with the winning bid. |
| | Clicking on the vendor name will show you contact information for the |
| | vendor. |
| Confirmation | Contains a link to the Confirmation Agreement. Click on the link to view |
| Agreement: | the Confirmation Agreement, the date and times it was signed, and the |
| | signatories' names. |
| Move to | Clicking the “Move to Past” link (see FIG. 16) will move the assignment |
| Past: | to the Assignments - Past screen. |
| | Do this only when the assignment is complete and you are ready to leave |
| | assignment feedback for the Vendor. |
| Extend: | If you need to extend an assignment past its original end date, use the |
| | Extend link (see FIG. 16). |
| | Pressing the “Extend” link will open the Extend Assignment screen (not |
| | shown). |
| Cancel: | Click on the cancel link (see FIG. 16) if you wish to cancel an |
| | assignment that is in progress. |
| | Clicking on “Cancel” will open the Cancel Assignment section in your |
| | browser. See, FIG. 10. |
| | Note: When an assignment is cancelled, all parties to the assignment are |
| | governed by the terms agreed to in the Master Agreement. |

### To Move an Active Assignment to “Past” Status:

It is time to move an assignment to past when the assignment has been completed and the hospital administrator is ready to leave feedback for the Vendor.

1. From the “Assignments—Active” section, click on the “Move to Past” link (see, FIG. 16) for the assignment to be moved.

2. Confirm the move by pressing “OK” when a message appears.

3. The assignment now automatically moves from the “Active” screen to the “Past” screen.

### To Extend an Assignment:

1. From the “Assignments—Active” section, click on the “Extend” link to the right of the assignment to be extended (see, FIG. 16).

2. On the “Extend Assignment” screen, select a “New End Date” for the assignment.

3. Press “Extend”. This will send an extension request to the vendor. (Note: The assignment is not extended until the vendor accepts the extension.)

### To Cancel an Assignment:

An assignment may also be cancelled using the “Cancel” link to the right of the assignment shown on the “Active Assignment” screen (FIG. 16). As discussed above, the “Cancel Assignment” screen will open (FIG. 10). Select a reason for cancellation from the drop down box.

3. Press “Save” to cancel the assignment.

Note: All cancellations are subject to the terms agreed upon in the corporate contract.

### Assignments Past:

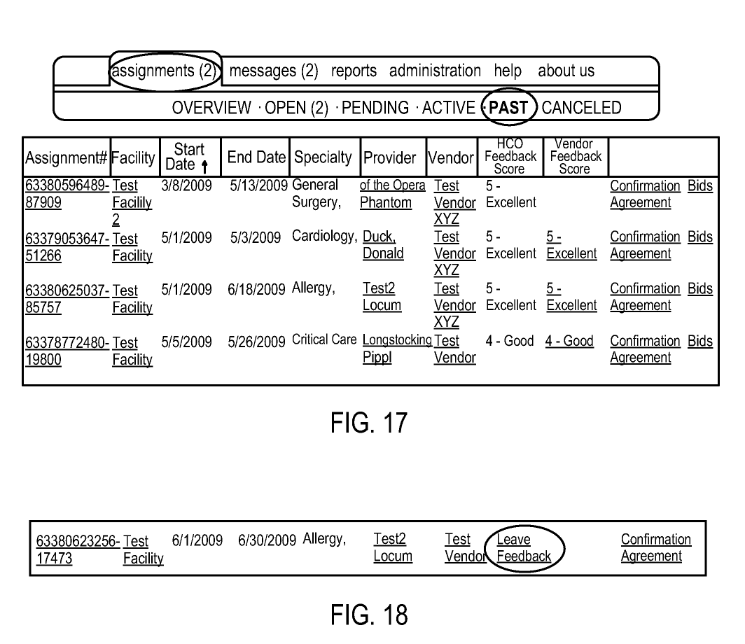

When an assignment is completed, it is “Moved to Past” and will then appear on the “Past” screen, FIG. 17. At this point, the hospital administrator is encouraged to leave feedback for the vendor about the assignment, the provider, and the experience working with the vendor. Likewise, the Vendor is encouraged to leave feedback about the assignment and their experience working with the hospital administrator.

The “Past” assignment table includes the following fields as shown in Table 7:

TABLE 7
Fields in Past Assignment Webpage Screen

| Field Name | Description or Sample Content |
|---|---|
| Assignment | The locumsmart.net generated number used to identify the assignment. |
| #: | Click on the assignment number link to view Assignment Details. |
| Facility: | Name of the facility and location where the assignment/provider worked. |
| | Clicking on the facility name will show you the contact information for |
| | the facility. |
| Start Date: | The first date the provider started work on the assignment. |
| End Date: | The last date the provider was available to work on the assignment. |
| Specialty: | The required specialty(s) of the Provider who worked this assignment. |
| Provider: | The name of the provider who worked the assignment. Click on the name |
| | to open the provider's record. |
| Vendor: | The name of the Vendor who staffed the assignment. Click on the name |
| | to view the vendor's contact information. |
| HCO | A numerical ranking will appear in this column once you have given |
| Feedback | feedback. Until that time, the column will read Leave Feedback. |
| Score: | The rankings range from: |
| | 1 = Poor |
| | 2 = Fair |
| | 3 = Average |
| | 4 = Good |
| | 5 = Excellent |
| | Click on the numerical ranking to open the feedback section and view |
| | specific comments. |
| | Note: You can edit your feedback for up to 2 months after the end date |
| | on the Confirmation Agreement. |
| Vendor | Once the vendor has left you feedback, a numerical ranking will appear |
| Feedback | in this column (see, FIG. 17). Until that time, the column will remain |
| Score: | empty. |
| | The rankings range from: |
| | 1 = Poor |
| | 2 = Fair |
| | 3 = Average |
| | 4 = Good |
| | 5 = Excellent |
| | Click on the numerical ranking to open the feedback section and view |
| | specific comments made by the vendor about the assignment. |
| | Note: The vendor can edit their feedback for up to 2 months after the end |
| | date on the Confirmation Agreement. |
| Confirmation | Contains a link to the Confirmation Agreement (see, FIG. 17). Click on |
| Agreement: | the link to view the Confirmation Agreement, the date and times it was |
| | signed, and the signatories' names. |
| Bids: | Click the link to view the details about the past bid(s) received for the |
| | assignment (see, FIG. 17). |

To View Feedback from Vendor:

1. From the “Assignments—Past” section, click on the “number” in the “Vendor Feedback Score” column.

2. The “View Feedback” screen will open (not shown).

3. A number will appear in the “Feedback Score” field. The rankings are as follows:
1=Poor
2=Fair
3=Average
4=Good
5=Excellent

4. The “Feedback” field will contain any specific comments made by the Vendor about the assignment or their experience working with the healthcare organization.

### To Leave Feedback for the Vendor:

1. From the “Assignments—Past” section, click on the “Leave Feedback” link in the “HCO Feedback Score” column (see, FIG. 18).

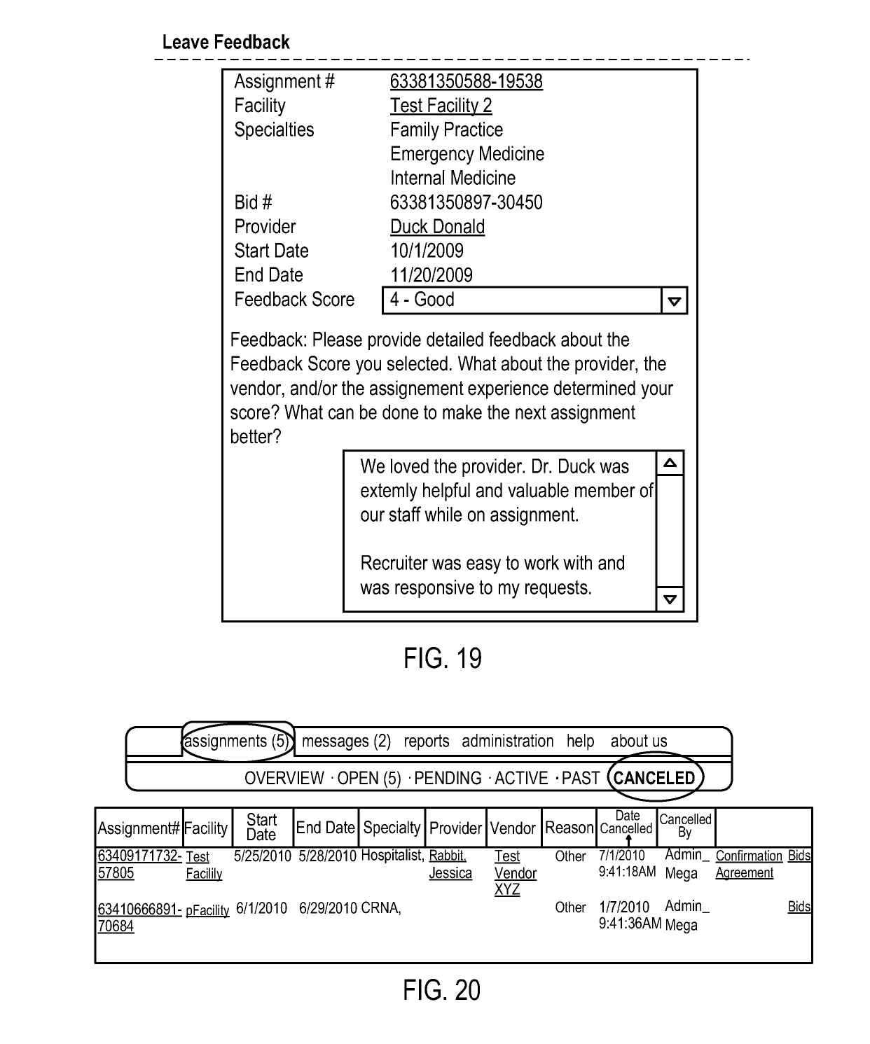

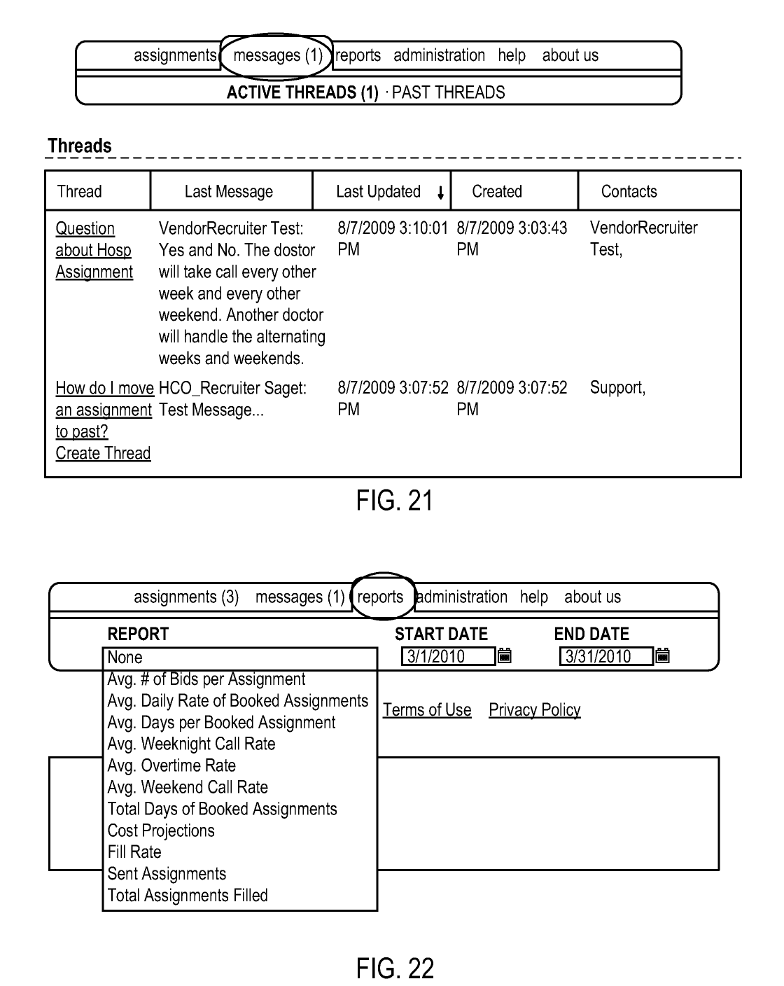

2. The “Leave Feedback” section will open as shown in FIG. 19.

3. The fields from “Assignment #” through “End Date” contain assignment recap information.

4. Select a number from the drop down box for the “Feedback Score” field. Use the following range when assigning your score:
1=Poor
2=Fair
3=Average
4=Good
5=Excellent

5. Add detailed comments in the “Feedback” field for the vendor. These comments should relate to the assignment and the hospital administrator's experience working with the vendor and provider. Remember, the Vendor will read these comments and see the Feedback Score assigned.

6. Press “Save”.

### To Modify Feedback Previously Left for the Vendor:

1. From the “Assignments—Past” section, click on the “score” in the “HCO Feedback Score” column (see, FIG. 17).

2. The “Leave Feedback” section will open and display previously left comments and score.

3. Modify the feedback comments and/or score.

4. Press “Save”.

### Assignments Cancelled:

When an assignment is cancelled, the assignment moves from an “Open”, “Pending”, or “Active” screen to a “Canceled” screen as shown in FIG. 20.

Clicking on any of the links in “Canceled” screen for a given assignment will display assignment information. In addition, the “Reason” column will indicate why the assignment was canceled, and the “Date Cancelled” and “Cancelled By” columns will indicate who canceled the assignment and when.

### Messages:

The messages section facilitates documented conversations between parties to an assignment. Using the “Messages” section is much like using an instant messenger program to hold a conversation within a given organization, e.g., between a hospital administrator and a vendor, or between a hospital administrator and LocumsMart Support personal. The record of the conversation will be captured in LocumsMart for future reference.

The Active Threads and Past Threads tabs include the following fields as shown in Table 8:

TABLE 8
Fields in the Active and Past Message Threads Webpage Screen

| Field Name | Description or Sample Content |
|---|---|
| Thread: | The general subject of the message. |
| Last | The most recent content posted in the thread. |
| Message: | |
| Last | Date and time of the last posting to the thread. |
| Updated: | |
| Created: | The date and time the thread was initially created and the |
| | conversation began. |
| Contacts: | The parties involved in the discussion. |
| Create | Link to start a new thread. Pressing “Create Thread” will |
| Thread: | open the Create Thread screen (not shown). |

Using the “Messages” webpage, a user can create and send a new message thread, upload any documents that are relevant to the message thread, choose the receiving party of the message thread, add a new contact for a receiving party if necessary, view a given thread (e.g., an active or past thread), respond to a given thread (e.g., an active or past thread), save all correspondence between the parties participating in a given message thread, and retrieve an archived thread.

### Reports:

The reports section contains reports that are populated with data related to a healthcare organization's specialties and facilities.

The Reports tab includes the following fields as shown in Table 9:

TABLE 9
Fields in the Reports Webpage Screen

| Field Name | Description |
|---|---|
| Report: | See table below for exact report names and descriptions. Your |
| | Confirmation Agreements for the chosen date range are used to populate |
| | the reports. |
| Start Date: | Use the calendar button to the right of this field to select the first date for |
| | the range of data. (ex. Jan. 1, 2009) |
| End Date: | Use the calendar button to the right of this field to select the last date for |
| | the range of data. (ex. Jun. 30, 2009) |
| Display Data | Select the criteria for the report you would like to view. Choose from All, |
| By: | Vendor, State, Specialty, Facility, and User. (Note: All criteria are not |
| | available for all reports.) |
| Save to | Select Left (or Right) to save a report to the Left (or Right) side of your |
| Overview: | Assignments - Overview screen. See, FIG. 4. |
| Graph Type: | Changing the Graph Type will automatically reformat the data into your |
| Pie, Bar, | preferred style. Different options (bar, line, or pie) are available based on |
| Line | the report and criteria you select. |

Table 10 below provides a list of exemplary reports that may be obtained from data used in the secure web-based system of the present invention:

TABLE 10
Exemplary Reports

| Field Name | Description |
|---|---|
| Avg # of Bids per | The average number of bids received per assignment during the |
| Assignment | chosen date range. |
| Avg Daily Rate of | The average daily rate (or hourly rate × 8) per assignment, |
| Booked | according to Confirmation Agreements executed during the chosen |
| Assignments | date range. |
| Avg Days per | The average number of days per booked assignment, according to |
| Booked | Confirmation Agreements accepted by the vendor during the |
| Assignment | chosen date range. |
| Avg Weeknight | The average weeknight call rate according to Confirmation |
| Call Rate | Agreements executed during the chosen date range. |
| Avg Overtime | The average overtime rate, according to Confirmation Agreements |
| Rate | executed during the chosen date range. |
| Avg Weekend Call | The average weekend call rate, according to Confirmation |
| Rate | Agreements executed during the chosen date range. |
| Total Days of | The total number of calendar days booked within the chosen date |
| Booked | range (according to the dates contained in each fully-executed |
| Assignments | Confirmation Agreement). |
| Cost Projections | The expected total cost of all Confirmation Agreements executed |
| | during the given date range. (Cost calculated using the formula: |
| | Confirmation Agreement Days × 5/7 (expected work days) × 1.25 |
| | (expected overtime) × Daily Rate) |
| Fill Rate | The percentage of assignments booked, according to Confirmation |
| | Agreements executed during the chosen date range. (Fill rate % = |
| | total # of assignment Confirmation Agreements accepted/total # of |
| | assignments submitted). |
| Sent Assignments | The total number of assignments sent during the chosen date range. |
| Total Assignments | The total number of booked assignments, according to |
| Filled | Confirmation Agreements executed during the chosen date range. |
| Activity Report for | Based on the start and end dates selected, and the facilities for |
| HCO | which you recruit, HCO users will find: |
| | A list of assignments booked during the date range. (Booked |
| | assignments are determined by the award of a Confirmation |
| | Agreement.) |
| | A list of new assignments that were first posted during the date |
| | range. |
| | A list of all assignments that were posted prior to the date range |
| | you selected, but remain open for vendor bids during the date range. |
| | A list of assignments that were canceled during the time frame |
| | you selected and the date each assignment was canceled. |
| | The number of bids received by the end date selected per |
| | assignment. |
| | Calendar Days (length) of each assignment. |
| | You also have the option to export the same data you view on the |
| | screen to an Excel spreadsheet. Simply press the “Export to Excel” |
| | link (not shown) and follow the prompts. |

### To Run a Report:

1. From the “Reports” tab (see, FIG. 22), locate the “Report” field and click on the report name to select the report to be viewed.

2. Select the start date (i.e. the first date to pull information).

3. Select the end date (i.e. the last date to pull information).

4. Select the report criteria from the “Display Data By” field. Table 11 provides field options:

TABLE 11
Display Date by Field Options for a Given Report

| Interval | Content |
|---|---|
| All: | Data is displayed as the overall total. |
| Vendor: | Data is grouped by vendor. |
| State: | Data is grouped by assignment state. |
| Specialty: | Data is grouped by assignment specialty. |
| Facility: | Data is grouped by assignment facility. |
| User: | Data is grouped by user. |

### To Save a Report:

The report will update on the computer screen with each selection made.

### To Save a Report:

1. Select preferred criteria and the report will be run.

2. On the report screen, press the “Left” or “Right” “Save to Overview” button (located on the bottom left side of the screen) to save the report to either the left or right side of your “Overview” screen (FIG. 4).

3. Press “OK” to confirm that request to replace the current report. The report is now saved to the “Overview” screen.

Note: You can change the reports that show up on the “Overview” screen simply by saving a new report using the same steps above. The new report will replace the older report.

### Administration:

The “Administration” tab of the “Assignments Overview” screen (FIG. 4) may be utilized to perform a number of functions. Possible functions include, but are not limited to, updating a hospital administrator's personal profile or a healthcare organization's profile; adding, editing or deleting a given Vendor (e.g., Recruiter, Credentialer, or Manager); viewing and changing the settings for a healthcare organization's Vendor contracts; adding, editing or deleting a given facility within a healthcare organization; resetting a user's password; managing and editing a master contract and master contract details for a given set of HCOs and vendors; viewing active and past master agreements; determining which documents are required by a given Corporate Contract (i.e., contract with a given HCO); reviewing a Locum Tenens Services Agreement with a given HCO for a given assignment; and reviewing any Addendums as most Addendums note required documentation.

### To Create a Bid:

1. From the “Assignments—Open” screen (see, FIG. 5), click on the “Bids” link to the right of the assignment on which to bid.

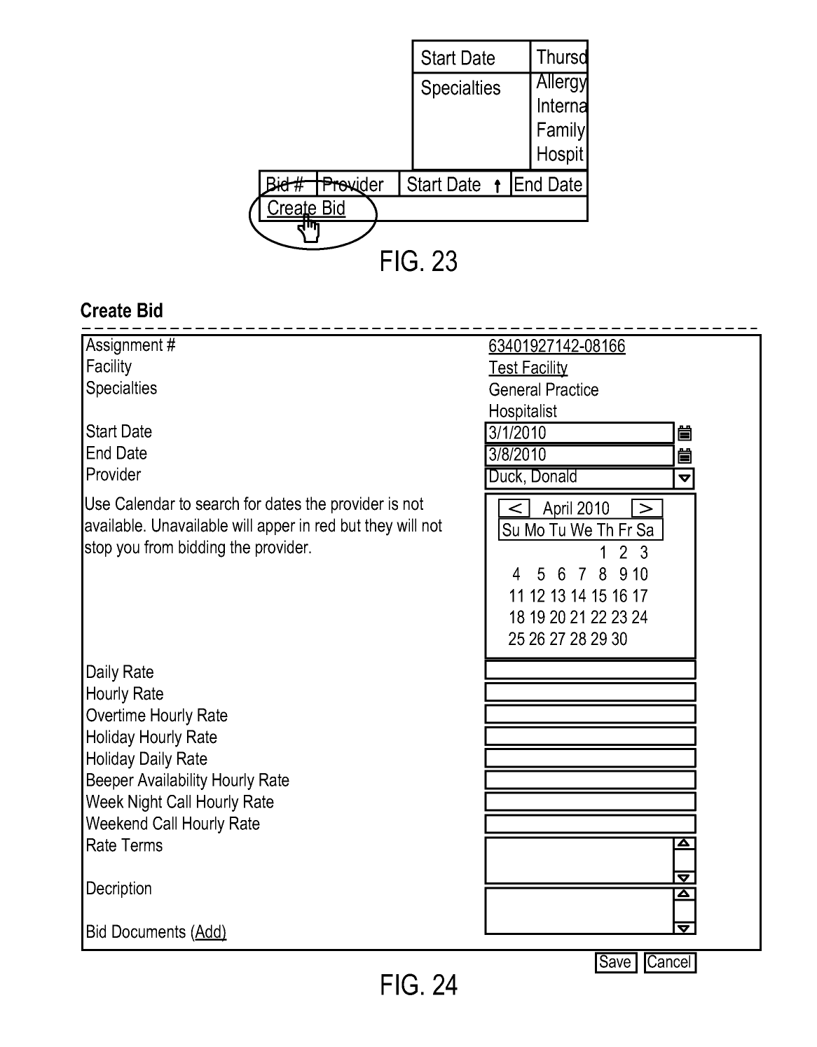

2. After the “Bids” section opens as shown in FIG. 23, click on the “Create Bid” link.

3. The “Create Bid” screen opens next as shown in FIG. 24. Fill in the applicable fields, which are shown in Table 12 below:

TABLE 12
Fields In Create Bid Screen

| Field Name | Description or Sample Content |
|---|---|
| Assignment | The locumsmart.net generated number used to identify the assignment. |
| #: | Clicking on the assignment number link will display the HCOs |
| | assignment details and contact information. |
| Facility: | Name of the location where the assignment is to be worked and where |
| | the provider is needed. Clicking on the facility name will show you the |
| | facility details including phone, address, and website. |
| Specialties: | Displays the specialty(s) of the provider that is needed to work this |
| | assignment. |
| Start Date: | The first date your provider is available to start work on this assignment |
| | if selected. Use the calendar button to the right of this field to select the |
| | date from the built in calendar. |
| End Date: | The last date your provider is available to work on this assignment if |
| | selected. Use the calendar button to the right of this field to select the |
| | date from the built in calendar. |
| Provider: | Select the name of your provider from the drop down list. You will only |
| | see providers included in this list that are on your Provider List (under |
| | Administration - Manage Providers) and are not booked for assignments |
| | during these same dates. If the provider you have in mind for this |
| | assignment is not on the list, see the Section titled: “To Add a New |
| | Provider's Record” to learn how to add the provider. |
| Calendar: | Use the Calendar to search for dates the provider is not available. |
| | Unavailable dates for the provider will appear in red font but they will |
| | not stop you from bidding the provider. |
| Daily Rate: | Your DAILY billing rate for this provider. |
| | Enter the dollar amount rounded to the nearest dollar (i.e. enter 125 and |
| | not 124.75). |
| | Do not enter a $ sign or other punctuation. |
| | Make sure to add a note to the Description field indicating the length of |
| | the day (ex. 8, 10, or 12 hour day). |
| Hourly Rate: | Your HOURLY billing rate for this provider. |
| | Enter the dollar amount rounded to the nearest dollar (i.e. enter 125 and |
| | not 124.75). |
| | Do not enter a $ sign or other punctuation. |
| Overtime | Your OVERTIME HOURLY billing rate for this provider. |
| Hourly Rate: | Consider adding a note to the Description field indicating when the OT |
| | rate goes into effect (ex. After 8 hours worked in a 24 hour period; after |
| | 40 hours worked per calendar week). |
| | Enter the dollar amount rounded to the nearest dollar (i.e. enter 125 and |
| | not 124.75). |
| | Do not enter a $ sign or other punctuation. |
| Holiday | Your HOLIDAY HOURLY billing rate for this provider. |
| Hourly Rate: | Enter the dollar amount rounded to the nearest dollar (i.e. enter 125 and |
| | not 124.75). |
| | Do not enter a $ sign or other punctuation. |
| Holiday | Your HOLIDAY DAILY billing rate for this provider. |
| Daily Rate: | Enter the dollar amount rounded to the nearest dollar (i.e. enter 125 and |
| | not 124.75). |
| | Do not enter a $ sign or other punctuation. |
| | Make sure to add a note to the Description field indicating the length of |
| | the day (ex. 8, 10, or 12 hour day). |
| Beeper | Your BEEPER AVAILALBITY HOURLY billing rate for this provider. |
| Availability | Enter the dollar amount rounded to the nearest dollar (i.e. enter 125 and |
| Hourly Rate: | not 124.75). |
| | Do not enter a $ sign or other punctuation. |
| Week Night | Your WEEK NIGHT CALL HOURLY billing rate for this provider. |
| Call Hourly | Enter the dollar amount rounded to the nearest dollar (i.e. enter 125 and |
| Rate: | not 124.75). |
| | Do not enter a $ sign or other punctuation. |
| Weekend | Your WEEKEND CALL HOURLY billing rate for this provider. |
| Call Hourly | Enter the dollar amount rounded to the nearest dollar (i.e. enter 125 and |
| Rate: | not 124.75). |
| | Do not enter a $ sign or other punctuation. |
| Rate Terms: | Use this field to add specifics about the rates or details of the rates you |
| | are bidding. Don't forget about your perm fee. |
| Description: | Add other notes here you wish the HCO to see when evaluating your bid. |
| Bid | Press the Add link to upload documents related to your bid. The HCO |
| Documents: | will see any documents you upload here and they will become part of |
| | your official bid. |
| | An example of a bid document you might upload is a Presentation Letter. |
| | Note: Documents must be under 10 mb in size. |

4. Press “Save” once all bid details have been entered. Pressing “Save” will send a bid to the HCO.

### To Edit a Bid:

Until the point that a bid is accepted or declined, bid information in a bid may be edited as follows:

1. From the “Assignments—Open” screen (FIG. 5), click on the “Bids” link to the right of the assignment bid to edit.

2. After the “Bids” section opens (FIG. 11), click on the “Bid #” of the bid to edit.

3. The “Edit Bid” screen opens next (not shown). Make any changes.

4. Press “Save” when bid updates are completed. Pressing “Save” will send updated bid details to the HCO.

### To Cancel a Bid:

1. From the “Assignments—Open” screen (FIG. 5), click on the “Bids” link to the right of the assignment bid to cancel.

2. After the “Bids” section opens (FIG. 11), click on the “Cancel” link to cancel a bid.

3. Press “OK” to confirm the cancellation.

4. The status for the bid will now be listed as “Canceled” (instead of “Active” as shown in FIG. 11).

### To Edit a Confirmation Agreement:

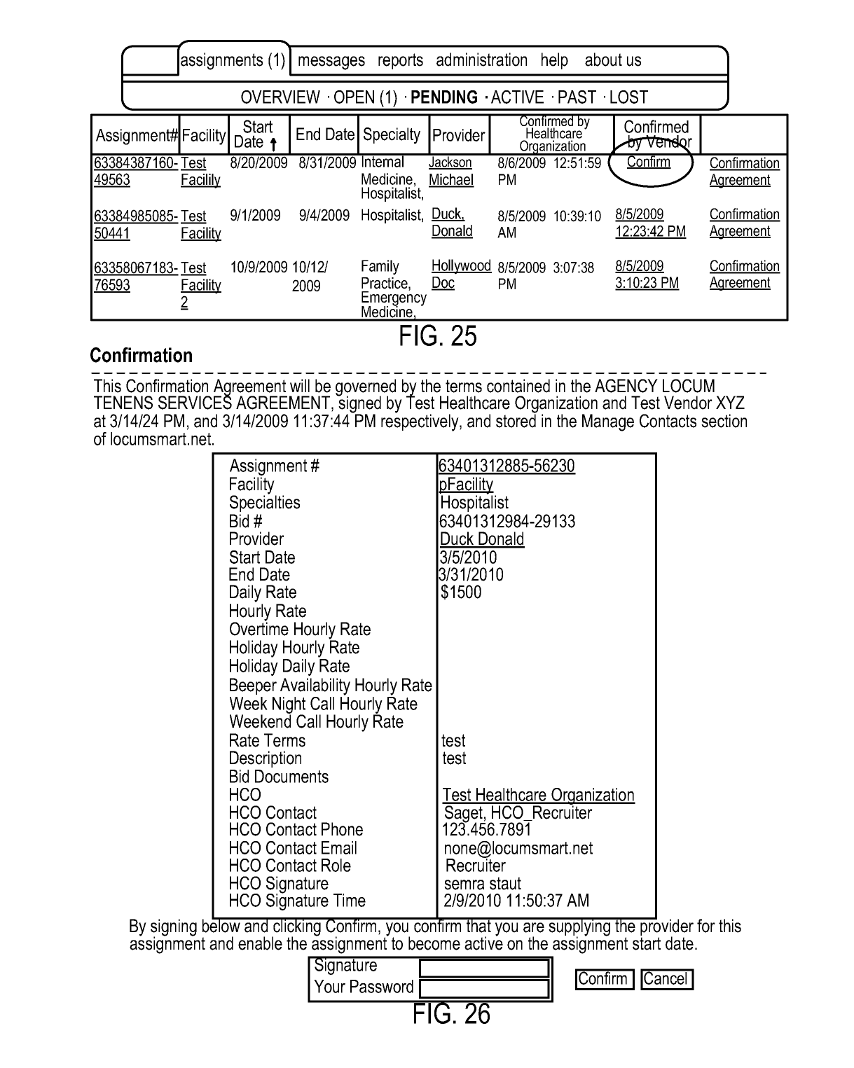

1. From the “Assignments—Pending” section (FIG. 14), click on the “Confirm” link for the assignment to confirm (see, FIG. 25).

2. The Confirmation Agreement will open on your screen as shown in FIG. 26.

3. Review the terms by scrolling to the bottom of the screen. Type a specific user name in the signature box and enter a specific password where requested.

4. Press “Confirm” to sign the Confirmation Agreement and accept the assignment.

### To Upload Assignment Documents:

See the description above for a discussion of potential documents. Upload documents that relate to the assignment and are a part of the files regarding the assignment.

1. From the “Assignments—Pending” screen (FIG. 25), click on the “Assignment #” link in the “Assignment #” field (i.e., of the assignment to be confirmed).

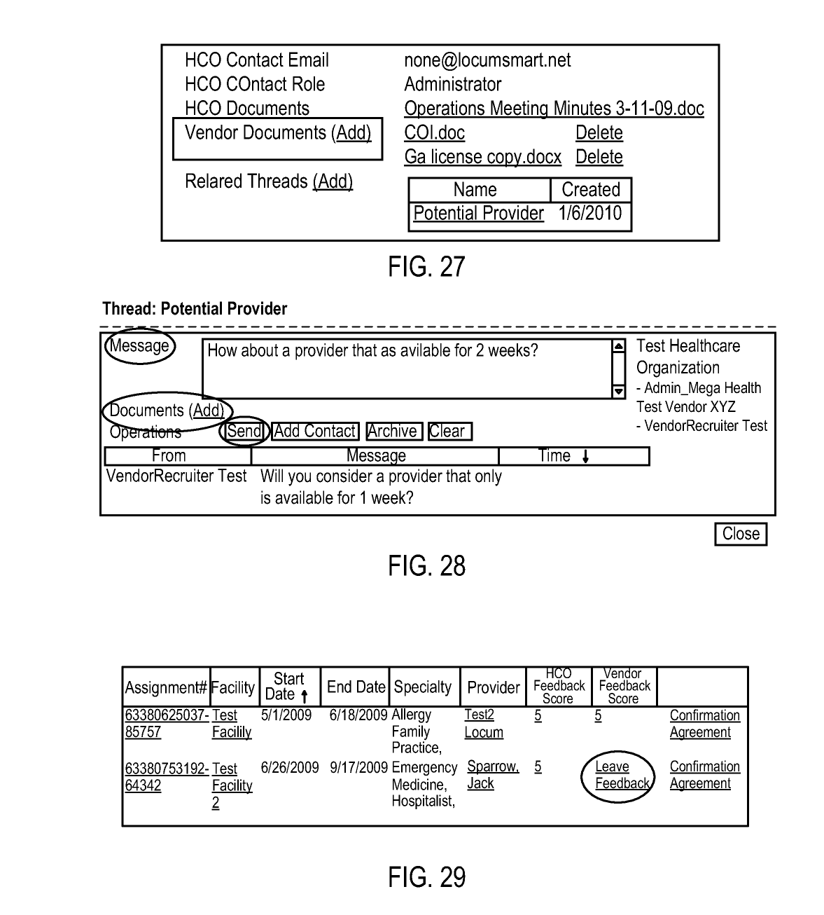

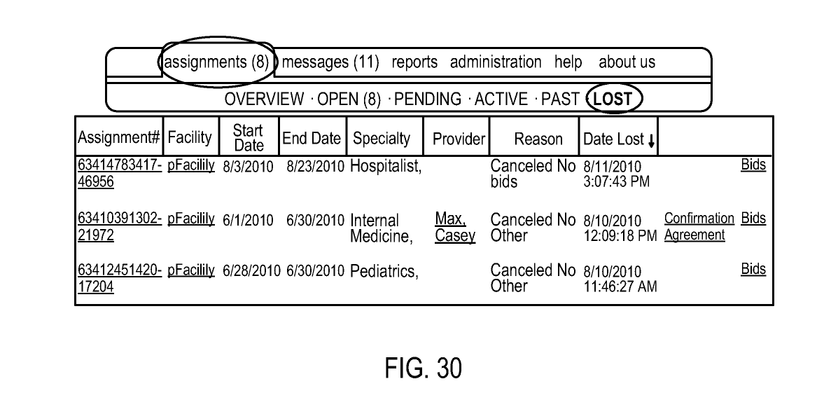

2. The Assignment Details screen will open as shown in FIG. 27. Locate the “Vendor Documents” field on the lower right side of the screen.

3. Press the “Add” link and a Browse button will display (not shown).

4. Press the “Browse” button to locate the document file on the computer being used. Follow the prompts to upload/attach the document to the assignment.

Notes:
Documents must be under 10 mb in size.
If an extra row that you wish to remove is added, press the “Delete” link.

5. If additional documents need to be uploaded, repeat steps 3 and 4 again.

6. The document(s) will be uploaded when “Save” is pressed.

### To Add an Assignment—Related Thread:

The assignment (related) thread feature (see FIG. 27) may be used to ask a question or comment for the HCO about the assignment. “Related Threads” are attached to assignment records, and any LocumsMart user that has access to the assignment can see the “Related Threads”. As a result, “Related Threads” are typically only used for generic communication about an assignment that is public in nature or for comments that one wishes all eligible vendors to see.

Note: Discussion between a vendor and the HCO should typically be handled by opening a thread directly with one or more users from the “Messages” tab as discussed above.

To add an assignment (related) thread:

1. From the “Assignment Details” screen (see FIG. 27), press the “Add” link to the right of the “Related Threads” field.

2. Press “OK” after reading the informational message.

3. On the next screen (not shown), enter a subject for the message, the text of the message, and upload any relevant documents.

4. Press “Save”.

The “Related Thread” is now posted and anyone with access to see the assignment will be able to view the thread.

### To Respond to an Assignment—Related Thread:

1. From the “Assignment Details” screen (FIG. 27), press the “Name” link to the right of the “Related Threads” field.

2. On the next screen as shown in FIG. 28, type a response in the “Message” field and upload any relevant documents.

3. Press “Send” and the message will be delivered.

A “Related Thread” is now posted and anyone with access to see the assignment will be able to view the thread (including any postings).

### To View Feedback Left by an HCO:

1. From the “Assignments—Past” section (FIG. 17), click on the “Number” in the “HCO Score Feedback” column.

2. The “View Feedback” screen (FIG. 19) will open.

3. The fields from “Assignment #” through “End Date” contain a recap of the assignment.

4. A number will appear in the “Feedback Score” field. The rankings are as follows:
1=Poor
2=Fair
3=Average
4=Good
5=Excellent

5. The “Feedback” field will contain any specific comments made by the HCO about the Provider, the assignment, or the Vendor.

### To Leave Feedback for a HCO:

1. From the “Assignments—Past” section, click on the “Leave Feedback” link in the “Vendor Feedback Score” column as shown in FIG. 29.

2. The “Leave Feedback” section will open (i.e., a “Leave Feedback” screen similar to FIG. 19).

3. The fields from “Assignment #” through “End Date” contain assignment recap information.

4. Select a number from the drop down box for the “Feedback Score” field. Use the following range when assigning a score:
1=Poor
2=Fair
3=Average
4=Good
5=Excellent

5. Add detailed comments in the “Feedback field” for the HCO. These comments should relate to the assignment and experience working with the HCO. Remember, the HCO will have the opportunity to read these comments and see the assigned Feedback Score.

6. Press “Save”.

### To Modify Feedback Previously Left for the HCO:

1. From the “Assignments—Past” section, click on the “score” in the “Vendor Feedback Score” column (see, FIG. 17).

2. The “Leave Feedback” section will open and display previously left comments and score.

3. Modify the feedback comments and/or score.

4. Press “Save”.

### Assignment—Lost:

When as assignment is canceled by the HCO or awarded to another vendor, the assignment moves from the “Open”, “Pending”, or “Active” screen to the “Canceled” screen.

Clicking on any of the links for the assignment will display assignment information. In addition, the “Reason” column will indicate why the assignment was lost, and the “Date Lost” column indicates when the assignment was lost. Use the “Bids” link to review any bids submitted for the assignment.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A method for matching a healthcare professional with a healthcare organization on a temporary basis, said method comprising:
providing a secure web-based system for healthcare organizations and vendors for the purpose of matching a healthcare professional with a healthcare organization on a temporary basis;
providing independent access to the secure web-based system via individual user names and passwords for (i) one or more healthcare facility administrators, (ii) one or more vendors, and (iii) one or more support personnel;
providing a first set of website selection options for the one or more healthcare facility administrators; and
providing a second set of website selection options for the one or more vendors;
wherein utilization of website selection options within the first and second sets of website selection options by the one or more healthcare facility administrators and the one or more vendors results in an accepted match between (1) a specific healthcare provider and (2) a specific facility of a healthcare organization for a temporary assignment performed by the specific healthcare provider at the specific facility.

2. The method of claim 1, wherein utilization of website selection options within the first and second sets of website selection options by the one or more healthcare facility administrators and the one or more vendors results in formation of a contractual agreement between (1) a specific vendor and (2) the specific facility for the temporary assignment to be performed by the specific healthcare provider at the specific facility.

3. The method of claim 1, wherein the first set of website selection options for the one or more healthcare facility administrators comprise a website selection option for accessing the secure web-based system by inputting an administrator user name and password specific to a given healthcare facility administrator; a website selection option for creating a new assignment for a temporary healthcare provider service at a specific facility; a website selection option for awarding the new assignment for the temporary healthcare provider service to a winning vendor; a website selection option for inputting assignment details for the new assignment so as to be viewable by one or more potential vendors for the new assignment; a website selection option for saving the new assignment; a website selection option for submitting the new assignment to one or more select vendors from a list of possible vendors; a website selection option for reviewing bids from one or more vendors by clicking on an individual bid number assigned to each bid; a website selection option for reviewing details of a potential healthcare provider; a website selection option for accepting or rejecting a given bid by clicking on a given bid number; a website selection option for inputting the administrator user name and password of the given healthcare facility administrator into designated fields associated with a winning bid number; a website selection option for creation of an electronic confirmation agreement which is made a part of and is governed by terms of a master agreement between the vendor and the healthcare organization; a website selection option for providing notice of acceptance of a winning bid to the winning vendor; and a website selection option for providing notice of a declined bid to a losing vendor.

4. The method of claim 3, wherein the first set of website selection options for the one or more healthcare facility administrators further comprises a website selection option for managing a transition of an awarded assignment to an active assignment; a website selection option for viewing a master agreement and any addendums for the winning vendor; a website selection option for determining and identifying documents that are required for the new assignment; a website selection option for entering a “Pending” screen from an “Assignments” screen; a website selection option for clicking on the specific healthcare provider's name to review the specific healthcare provider's provided documents; a website selection option for clicking on a given assignment number and viewing documents specific to the new assignment that have been uploaded by the winning vendor; a website selection option for contacting the winning vendor if any documents are missing; a website selection option for clicking on an assignment number assigned to the new assignment so as to view documents uploaded by the vendor; a website selection option for uploading any missing documents for the new assignment; and a website selection option for clicking on a “Move to Active” link and pressing “OK” when all documentation is verified as being complete and the specific healthcare provider is ready to begin work on the new assignment.

5. The method of claim 4, wherein the first set of website selection options for the one or more healthcare facility administrators further comprises a website selection option for managing details of one or more active assignments; a website selection option for extending an assignment end date; a website selection option for editing original bid details to indicate an extension of an end date of the assignment associated with the original bid; a website selection option for executing a confirmation agreement for the extension; a website selection option for moving an assignment from an active status to a completed status when the assignment is completed; a website selection option for managing details of a past assignment; a website selection option for providing feedback to the winning vendor and the specific healthcare provider regarding performance of the new assignment; a website selection option for saving any feedback; a website selection option for editing the feedback for a period of time; and a website selection option for viewing feedback provided by the winning vendor.

6. The method of claim 1, wherein the second set of website selection options for the one or more vendors comprise a website selection option for accessing the secure web-based system by inputting a vendor user name and password specific to a given vendor; a website selection option for reviewing one or more assignments; reviewing uploaded documents or messages provided by one or more hospital administrators; adding a new provider for consideration for a given assignment; inputting provider details; uploading a provider's curriculum vitae (CV), references and any other documentation for the provider; and in response to receiving a request to bid on one or more assignments from a hospital administrator, submitting a bid for the one or more assignments.

7. The method of claim 6, wherein the second set of website selection options further comprises a website selection option for reviewing one or more declined bids; a website selection option for determining why a given bid was declined; a website selection option for submitting a revised bid in response to receiving a declined bid; a website selection option for reviewing one or more awarded assignments selected by the hospital administrator due to one or more winning bids; a website selection option for signing a confirmation agreement for each awarded assignment; a website selection option for viewing a master agreement and any addendums; a website selection option for determining which documents the winning vendor is required to provide for the awarded assignment; a website selection option for reviewing documents uploaded for a given provider; a website selection option for uploading documents, as needed, for a given provider; a website selection option for reviewing assignments that the hospital administrator has determined to be complete and ready to start; a website selection option for reviewing a new assignment in response to receiving notification that the hospital administrator wishes to extend an end date of given active assignment; and if accepting the extension, a website selection option for completing a new assignment and executing a confirmation agreement for the extension.

8. The method of claim 7, wherein the second set of website selection options further comprises a website selection option for reviewing past assignments that the hospital administrator has determined to be completed; a website selection option for leaving feedback for the hospital administrator; a website selection option for editing any vendor provided feedback for a period of time; and a website selection option for viewing feedback provided by the hospital administrator for a given completed assignment.

9. A computing system containing at least one application module usable on the computing system, wherein the at least one application module comprises application code loaded thereon for performing the method of claim 1.

10. A computing system comprising at least one device operatively adapted to access the secure web-based system and utilize the method of claim 1 so as to facilitate reaching the accepted match between (1) the specific healthcare provider and (2) the specific facility of the healthcare organization for the temporary assignment performed by the specific healthcare provider at the specific facility.

11. A method for matching a healthcare professional with a healthcare organization on a temporary basis, said method comprising:
creating an assignment for temporary healthcare provider services using a secure web-based system;
submitting the assignment along with a request to bid on the assignment to one or more potential bidders via the secure web-based system;
in response to receiving one or more bids from the one or more potential bidders for the assignment via the secure web-based system, accepting a bid for the assignment via the secure web-based system, wherein said accepting step creates an electronic confirmation agreement that is made a part of and governed under terms of a master agreement between the healthcare organization and a winning bidder; and
providing notification of acceptance to the winning bidder for an accepted bid via the secure web-based system.

12. The method of claim 11, wherein said method further comprises one or more steps selected from:
accessing a web-based program for matching a healthcare professional with a healthcare organization on a temporary basis by using a user name and password;
providing assignment details that may be viewable by one or more potential bidders for the assignment;
reviewing bids from one or more bidders including bid details, wherein the bid details comprise bid rates;
reviewing details of a potential healthcare provider reference in a bid, wherein the details of the potential healthcare provider comprise one or more of: a curriculum vitae of the provider, references, copies of certifications and licenses, a national provider identifier (NPI) number of the provider, and employment eligibility verification documents; and
providing notice of a declined bid to a bidder.

13. The invention of claim 12, wherein said method further comprises one or more steps selected from:
managing a transition of an awarded assignment to an active assignment;
managing details of an active assignment while the assignment has an active status; and
managing the aspects of a past or completed assignment.

14. The method of claim 11, wherein said method further comprises:
in response to receiving a request to bid on one or more assignments from a hospital administrator, submitting a bid for the one or more assignments;
in response to receiving notification of acceptance of the bid, electronically signing a confirmation agreement for the assignment via the secure web-based system.

15. The method of claim 11, wherein the master agreement comprises a single contract used by all hospital administrators and vendors, the single contract being pre-approved by all hospital administrators and vendors prior to creation of a new assignment and comprises one of more features selected from: the single contract covers all healthcare specialties; the single contract covers all facilities within a given healthcare organization (HCO) that use the secure web-based system; the single contract covers all the HCO's preferred vendors; the single contract automatically renews each year; the single contract comprises no rate sheets; the single contract requires vendors to carry professional liability insurance policies meeting certain quality standards; the single contract provides a cancellation period; the single contract provides a procuring cause period for candidate presentations; the single contract requires each vendor to provide documentation for each provider, wherein the documentation comprises one or more of: a provider's CV, references, copies of certifications and licenses, a provider's national provider identifier (NPI) or AANA number, employment eligibility verification documents, or any combination thereof; the single contract allows assignments and bids to take place through the LocumsMart portal; the single contract enables confirmation agreements to be signed and stored electronically; and the single contract allows for predetermined permanent placement fees.

16. A computing system containing at least one application module usable on the computing system, wherein the at least one application module comprises application code loaded thereon for performing the method of claim 15.

17. A computing system comprising at least one device operatively adapted to access the secure web-based system and utilize the method of claim 11 so as to facilitate reaching an accepted match between (1) a specific healthcare provider and (2) a specific facility of the healthcare organization for the temporary assignment performed by the specific healthcare provider at the specific facility.

18. A method for connecting vendors and healthcare organizations for the purpose of matching a healthcare professional with a healthcare organization on a temporary basis, said method comprising:
in response to receiving a request to bid on an assignment for temporary healthcare provider services from a hospital administrator via a secure web-based system, submitting a bid for the assignment via the secure web-based system; and
in response to receiving notification of acceptance of the bid from the hospital administrator, electronically signing a confirmation agreement for the assignment via the secure web-based system.

19. The method of claim 18, wherein the electronic confirmation agreement forms part of and is governed under terms of a master agreement between a healthcare organization and a winning bidder, the master agreement comprising a single contract used by all hospital administrators and vendors, the single contract being pre-approved by all hospital administrators and vendors prior to creation of a new assignment and comprises one of more features selected from: the single contract covers all healthcare specialties; the single contract covers all facilities within a given healthcare organization (HCO) that use the secure web-based system; the single contract covers all the HCO's preferred vendors; the single contract automatically renews each year; the single contract comprises no rate sheets; the single contract requires vendors to carry professional liability insurance policies meeting certain quality standards; the single contract provides a cancellation period; the single contract provides a procuring cause period for candidate presentations; the single contract requires each vendor to provide documentation for each provider, wherein the documentation comprises one or more of: a provider's CV, references, copies of certifications and licenses, a provider's national provider identifier (NPI) or AANA number, employment eligibility verification documents, or any combination thereof; the single contract allows assignments and bids to take place through the LocumsMart portal; the single contract enables confirmation agreements to be signed and stored electronically; and the single contract allows for predetermined permanent placement fees.

20. A computing system containing at least one application module usable on the computing system, wherein the at least one application module comprises application code loaded thereon for performing the method of claim 18.
